(19) United States
(12) Patent Application Publication
(10) Pub. No.: US 2025/0048248 A1
(43) Pub. Date: Feb. 6, 2025

(54) METHOD FOR PROVISIONING CELL SELECTION OR RESELECTION IN A NON-TERRESTRIAL NETWORK AND USER EQUIPMENT UTILIZING THE SAME

(71) Applicant: SAMSUNG ELECTRONICS CO., LTD., Suwon-si (KR)

(72) Inventors: Nishant ., Bangalore (IN); Amit Anadrao DANGE, Bangalore (IN); Vivek MURUGAIYAN, Bangalore (IN); Kailash Kumar JHA, Bangalore (IN); Mohammad UMAIR, Bangalore (IN); Gokul K, Bangalore (IN); Nitesh Pushpak SHAH, Bangalore (IN)

(73) Assignee: SAMSUNG ELECTRONICS CO., LTD., Suwon-si (KR)

(21) Appl. No.: 18/790,820

(22) Filed: Jul. 31, 2024

(30) Foreign Application Priority Data
Jul. 31, 2023 (IN) 202341051453
Mar. 18, 2024 (IN) 202341051453

(51) Int. Cl. H04W 48/20; H04W 72/0453; H04W 72/56; H04W 76/27

(52) U.S. Cl. CPC H04W 48/20; H04W 72/0453; H04W 72/56; H04W 76/27

(57) ABSTRACT

A method, performed by a user equipment (UE) camping on a serving cell in a non-terrestrial network (NTN), for provisioning cell selection or reselection in the NTN, includes: receiving, by the UE from the serving cell, a first message comprising a first set of information; receiving, by the UE, a second message comprising a second set of information broadcasted by the serving cell, wherein the second set of information comprises information that is at least partially different from the first set of information; generating, by the UE, a cell selection or reselection list based on the first set of information and the second set of information, wherein the cell selection or reselection list comprises a plurality of candidate cells; and performing, by the UE, at least one network cell selection or reselection operation based on the cell selection or reselection list.

### CROSS-REFERENCE TO RELATED APPLICATIONS

This application is based on and claims priority under 35 U.S.C. § 119 to Indian Provisional Application No. 202341051453, filed on Jul. 31, 2023, and Indian Complete Application No. 202341051453, filed on Mar. 18, 2024, in the Indian Intellectual Property Office, the disclosures of which are incorporated by reference herein in their entireties.

### BACKGROUND

### 1. Field

The disclosure relates to a wireless communication, and more specifically, to provisioning cell selection or reselection and connected state measurement in a non-terrestrial network (NTN) network.

### 2. Description of Related Art

Although 5th Generation (5G) services were initially targeted towards consumers with smartphones, there is growing interest among network operators to expand these services to various industries. This demand for consistent service provision is expected to drive the evolution and expansion of networks into unconventional domains. One pivotal aspect of this gradual transition is the emergence of the NTN network. These wireless communication systems operate beyond Earth's surface, incorporating satellites in low Earth orbit (LEO), medium Earth orbit (MEO), and geostationary orbit (GEO), as well as high-altitude platforms (HAPS) and drones. NTN networks are essential for achieving seamless coverage, particularly in remote areas that lack access to conventional terrestrial networks. Utilizing telecommunications through NTN is perceived as the next step in extending the accessibility of 5G network services.

The NTN networks, earth-fixed, earth-moving or other deployment cases, pose a unique set of challenges that are considerably more intricate to overcome when compared to traditional terrestrial networks (TN). With their vast coverage and high-speed mobility, achieving stable and uninterrupted NTN services necessitates precise User Equipment (UE) camping and mobility procedures, including cell selection, reselection, and handover. To assist the UE in making intelligent and optimized decisions, the NTN networks transmit satellite assistance information via system broadcast information messages in the System Information Block (SIB) 19. It is incumbent upon the UE implementations to integrate the provided satellite assistance information to make informed decisions while connected to the NTN networks.

Furthermore, when the UE operates in the RRC_IDLE/RRC_INACTIVE state, it can perform a cell reselection procedure to transition from the current serving NTN cell to a more appropriate one. The selection of a new cell during this procedure is dependent on various factors, such as signal strength and cell priority. Information about neighboring cells and their priorities is conveyed to the UE through system broadcast message SIB4 or in an RRC reconfiguration message. Upon receiving this broadcasted information, the UE evaluates the available neighboring cells and initiates the cell reselection procedure accordingly. Similarly, in the RRC_CONNECTED state, the UE assesses cells configured in the RRC reconfiguration message as measurement objects and communicates this information to the network. Based on the suitability of the reported cells, the network issues a handover command to the UE for a seamless transition to the most optimal cell.

In NTN networks, the serving NTN cell spans a vast area, and nearby NTN cells may be few and far between. Therefore, it is imperative that the cell reselection/handover process is precise to avoid any service interruptions for end users. In NTN networks, in addition to the standard SIB4 message and measurement configuration list, information about neighboring NTN cells is obtained from satellite assistance information using SIB19 message and other configuration elements in the RRC reconfiguration message. As per 3GPP standards, during NTN cell reselection, UE implementations must consider cells listed in both the SIB4 message and the SIB19 message when there are differences in the neighbor cell lists between these sources. Similarly, in the RRC_CONNECTED state, UE implementations must choose cells for measurement reporting and handover procedures from neighboring cells configured in the RRC reconfiguration message and satellite assistance information in the NTN network. However, the current mechanism only permits specific cells to be considered for cell reselection, which may not always ensure mobility to the most suitable cell.

### SUMMARY

Provided is a provisioning cell selection or reselection in a non-terrestrial network. Provided is to camp on a serving NTN cell by a UE. Provided is to receive a first message comprising a first set of information from the serving NTN cell by the UE. Provided is to receive a second message comprising a second set of information from the serving NTN cell by the UE. The second set of information is one of completely different information or partially different information from the first set of information.

Provided is to generate a cell selection or reselection list based on the first set of information and the second set of information by the UE. The cell selection or reselection list includes a plurality of candidate cells. Provided is to receive a third message comprising a third set of information from at least one neighbor UE associated with the serving NTN cell. The third message includes at least one of satellite assistant information of the serving NTN cell, and SIB information associated with at least one candidate cell from the plurality of candidate cells.

Provided is to generate the cell selection or reselection list by mapping the first set of information and the second set of information with the third set of information. Provided is to use a short-range communication between the UE and the neighbor UEs associated with the serving NTN cell to receive the third message. Provided is to select an optimal candidate cell from the cell selection or reselection list by the UE.

Provided is to perform measurements of at least one candidate cell from the plurality of candidate cells, select an optimal candidate cell from the cell selection or reselection list based on the measurements and perform a handover procedure on an optimal frequency associated with the optimal candidate cell by the UE.

Provided is to select an optimal candidate cell from the cell selection or reselection list, and select an optimal frequency of at least one candidate cell from the plurality of candidate cells for cell selection or reselection by the UE.

Provided is to assign priorities to at least one first candidate cell and at least one second candidate cell for selecting the optimal candidate cell. Provided is to perform network cell selection or reselection operation based on the cell selection or reselection list.

According to an aspect of the disclosure, a method, performed by a user equipment (UE) camping on a serving cell in a non-terrestrial network (NTN), for provisioning cell selection or reselection in the NTN, includes: receiving, by the UE from the serving cell, a first message comprising a first set of information; receiving, by the UE, a second message comprising a second set of information broadcasted by the serving cell, wherein the second set of information comprises information that is at least partially different from the first set of information; generating, by the UE, a cell selection or reselection list based on the first set of information and the second set of information, wherein the cell selection or reselection list comprises a plurality of candidate cells; and performing, by the UE, at least one network cell selection or reselection operation based on the cell selection or reselection list.

When the UE is in an idle state, the first message may be a first system information block (SIB) message and the second message may be a second SIB message.

When the UE is in a connected state, the first message is a Radio Resource Control (RRC) reconfiguration message and the second message may be a second SIB message.

The first set of information may include: cell information of at least one first candidate cells of the plurality of candidate cells, and at least one of: at least one frequency information of at least one candidate cell of the plurality of candidate cells, and priority information of the at least one candidate cell.

The information that is at least partially different from the first set of information may include: at least one of cell information of at least one second candidate cell of the plurality of candidate cells, satellite assistant information, at least one frequency information of the at least one second candidate cell of the plurality of candidate cells, and priority information of the at least one second candidate cell.

The generating, by the UE, the cell selection or reselection list based on the first set of information and the second set of information may include: receiving, by the UE, a third message comprising a third set of information from at least one neighbor UE associated with the serving cell, and generating, by the UE, the cell selection or reselection list by mapping the first set of information and the second set of information with the third set of information, and wherein the third message may include: at least one of satellite assistant information of the serving cell, and SIB information associated with at least one candidate cell from the plurality of candidate cells.

The receiving, by the UE, the third message may include receiving the third message through a short-range communication between the UE and neighbor UEs associated with the serving cell.

The performing, by the UE, the at least one network cell selection or reselection operation based on the cell selection or reselection list may include at least one of: selecting, by the UE, an optimal candidate cell from the cell selection or reselection list; performing, by the UE, measurements of at least one candidate cell from the plurality of candidate cells, selecting, by the UE, the optimal candidate cell from the cell selection or reselection list based on the measurements, sending, by the UE, a measurement report comprising the measurements to the optimal candidate cell, receiving, by the UE, a handover command from the optimal candidate cell, and performing, by the UE, a handover procedure on an optimal frequency associated with the optimal candidate cell; and selecting, by the UE, the optimal candidate cell from the cell selection or reselection list, and selecting, by the UE, an optimal frequency of at least one candidate cell from the plurality of candidate cells for the cell selection or reselection.

The selecting, by the UE, the optimal candidate cell from the cell selection or reselection list may include: assigning a first priority to at least one first candidate cell and a second priority to at least one second candidate cell in the cell selection or reselection list, wherein the at least one first candidate cell is retrieved from the first set of information, the at least one second candidate cell is retrieved from the second set of information, and the second priority is lower than the first priority; selecting, by the UE, the optimal candidate cell from the at least one first candidate cell by evaluating the at least one first candidate cell based on the first priority and a third set of information received from at least one neighbor UE associated with the serving cell; and selecting, by the UE, the optimal candidate cell from the at least one second candidate cell by evaluating the at least one second candidate cell based on the second priority and the third set of information received from the at least one neighbor UE associated with the serving cell, when the at least one first candidate cell are not the optimal candidate cell.

According to an aspect of the disclosure, a user equipment (UE) for provisioning cell selection or reselection in a non-terrestrial network (NTN), includes: at least one memory configured to store information of the serving cell; at least one processor; and a cell selection or reselection provisioning controller, communicatively coupled to the at least one memory and the at least one processor, wherein the cell selection or reselection provisioning controller is configured to: camp the UE on a serving cell in the NTN; receive a first message comprising a first set of information from the serving cell; receive a second message comprising a second set of information broadcasted by the serving cell, wherein the second set of information comprises information that is at least partially different from the first set of information; generate a cell selection or reselection list based on the first set of information and the second set of information, wherein the cell selection or reselection list comprises a plurality of candidate cells; and perform at least one network cell selection or reselection operation based on the cell selection or reselection list.

When the UE is in an idle state, the first message may be a first system information block (SIB) message and the second message may be a second SIB message.

When the UE is in a connected state, the first message may be a Radio Resource Control (RRC) message and the second message may be a second SIB message.

The first set of information may include: cell information of the at least one first candidate cell of the plurality of candidate cells, and at least one of: at least one frequency information of at least one candidate cell of the plurality of candidate cells, and priority information of the at least one candidate cell.

The information that is at least partially different information from the first set of information may include at least one of: cell information of at least one second candidate cell of the plurality of candidate cells, satellite assistant information, at least one frequency information of at least one second candidate cell of the plurality of candidate cells, and priority information of the at least one second candidate cell.

The cell selection or reselection provisioning controller may be further configured to generate the cell selection or reselection list based on the first set of information and the second set of information by: receiving a third message comprising the third set of information from the at least one neighbor UE associated with the serving cell, wherein the third message comprises at least one of satellite assistant information of the serving cell, and SIB information associated with the at least one candidate cell from the plurality of candidate cells; and generating the cell selection or reselection list by mapping the first set of information and the second set of information with the third set of information.

The third message may be received through a short-range communication between the UE and neighbor UEs associated with the serving cell.

The cell selection or reselection provisioning controller may be further configured to perform the at least one network cell selection or reselection operation based on the cell selection or reselection list by at least one of: selecting an optimal candidate cell from the cell selection or reselection list; performing measurements of at least one candidate cell from the plurality of candidate cells, selecting the optimal candidate cell from the cell selection or reselection list based on the measurements, sending a measurement report comprising the measurements to the optimal candidate cell, receiving a handover command from the optimal candidate cell, and performing a handover procedure on an optimal frequency associated with the optimal candidate cell; and selecting the optimal candidate cell from the cell selection or reselection list, and selecting an optimal frequency of at least one candidate cell from the plurality of candidate cells for cell selection or reselection.

The cell selection or reselection provisioning controller may be further configured to select the optimal candidate cell from the cell selection or reselection list by: assigning a first priority to at least one first candidate cell and a second priority to at least one second candidate cell in the cell selection or reselection list, wherein the at least one first candidate cell is retrieved from the first set of information, the at least one second candidate cell is retrieved from the second set of information, and the second priority is lower than the first priority; selecting the optimal candidate cell from the at least one first candidate cell by evaluating the at least one first candidate cell based on the first priority and a third set of information received from at least one neighbor UE associated with the serving cell; and selecting the optimal candidate cell from the at least one second candidate cell by evaluating the at least one second candidate cell based on the second priority and the third set of information received from the at least one neighbor UE associated with the serving cell, when the at least one first candidate cell are not the optimal candidate cell.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a sequence diagram that illustrates improper NTN cell reselection, where the SIB4 message cells are not evaluated during a NTN cell reselection, according to the embodiment disclosed herein;

FIG. 2 is a schematic diagram that illustrates the possibility of improper NTN cell reselection, where the SIB4 message cells are not evaluated during the NTN cell reselection, according to the embodiment disclosed herein;

FIG. 3 is a schematic diagram that illustrates the frequencies/cells present in the SIB4 message but not in the SIB19 message, according to the embodiment disclosed herein;

FIG. 4 is a sequence diagram that illustrates improper NTN handover, where measurement object NTN frequency/cells in a SIB19 message are not measured during handover, according to the embodiment disclosed herein;

FIG. 5 is a schematic diagram that illustrates the possibility of improper NTN cell handover, where measurement object frequencies/cells not present in the SIB19 message gets skipped, according to the embodiment disclosed herein;

FIG. 6 is a schematic diagram that illustrates the NTN cells present in a RRC reconfiguration message but not in the SIB19 message, according to the embodiment disclosed herein;

FIG. 7 is a sequence diagram that illustrates improper NTN cell reselection, where the SIB19 message cells are not evaluated during reselection, according to the embodiment disclosed herein;

FIG. 8 is a schematic diagram that illustrates the possibility of improper NTN cell reselection, where frequencies/cells present only in the SIB19 message but not present in the SIB4 message are evaluated, according to the embodiment disclosed herein;

FIG. 9 is a schematic diagram that illustrates the frequencies/cells present only in the SIB19 message but not present in the SIB4 message, according to the embodiment disclosed herein;

FIG. 10 is a block diagram illustrating various hardware components of the UE for provisioning the cell reselection and connected mode measurement in the NTN Networks, according to the embodiment disclosed herein;

FIG. 11 is a flowchart that illustrates a method for provisioning cell selection or reselection in the NTN by the UE, according to the embodiment disclosed herein;

FIG. 12 is a sequence diagram that illustrates acquiring the SIB19 message information of the neighbor UE through the BLE mechanism to use during cell reselection, according to the embodiment disclosed herein;

FIG. 13 is a schematic diagram that illustrates acquiring the SIB19 message information of the neighbor UE through the BLE mechanism to use during the cell reselection, according to the embodiment disclosed herein;

FIG. 14 is a sequence diagram that illustrates acquiring neighbor cell information in the RRC reconfiguration message of the neighbor UE through the BLE mechanism, according to the embodiment disclosed herein;

FIG. 15 is a schematic diagram that illustrates acquiring neighbor cell information in the RRC reconfiguration message of the neighbor UE through the BLE mechanism, according to the embodiment disclosed herein;

FIG. 16 is a sequence diagram that illustrates acquiring the SIB19 message information of the neighbor UE through the BLE mechanism to use during connected state measurements, according to the embodiment disclosed herein;

FIG. 17 is a schematic diagram that illustrates acquiring the SIB19 message information of the neighbor UE through the BLE mechanism to use during connected state measurements, according to the embodiment disclosed herein;

FIG. 18 is a sequence diagram that illustrates all measurement object cells are measured during handover, according to the embodiment disclosed herein;

FIG. 19 is a schematic diagram that illustrates all measurement object cells that are measured during handover, according to the embodiment disclosed herein;

FIG. 20 is a sequence diagram that illustrates the SIB19 message cells evaluated during the NTN cell reselection, according to the embodiment disclosed herein;

FIG. 21 is a schematic diagram that illustrates the SIB19 message cells evaluated during the NTN cell reselection, according to the embodiment disclosed herein;

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the one or more embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help improve the understanding of aspects of the invention. Furthermore, the elements may have been represented in the drawing by conventional symbols, and the drawings may show only those specific details that are pertinent to the understanding of the embodiments of the invention so as not to obscure the drawing with details that will be readily apparent to those of ordinary skill in the art having the benefit of the description herein.

As is traditional in the field, embodiments are described and illustrated in terms of blocks that carry out a described function or functions. These blocks, which are referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Throughout the description, the terms “idle state” and “RRC_IDLE state” are used interchangeably. Throughout the description, the terms “connected state” and “RRC_CONNECTED state” are used interchangeably.

Embodiments disclosed herein provide a method for provisioning cell selection or reselection in an NTN network by a UE. The method includes camping on a serving NTN cell in the NTN network by the UE. Further, the method includes receiving a first message comprising a first set of information and a second message comprising a second set of information broadcasted by the serving NTN cell. The second set of information is one of completely different information or partially different information from the first set of information. The method further includes generating a cell selection or reselection list based on the first set of information and the second set of information by the UE. The cell selection or reselection list comprises a plurality of candidate cells. The method further includes performing at least one network cell selection or reselection operation based on the cell selection or reselection list.

Embodiments disclosed herein provide the UE for provisioning cell selection or reselection in the NTN networks. The UE includes at least one memory configured to store information of the serving NTN cell, a processor and a cell selection or reselection provisioning controller, communicatively coupled to the memory and the processor. The cell selection or reselection provisioning controller camps the UE on the serving NTN cell in the NTN. The cell selection or reselection provisioning controller receives the first message comprising the first set of information and the second message comprising the second set of information broadcasted by the serving NTN cell. The second set of information is one of completely different information or partially different information from the first set of information. Further, the cell selection or reselection provisioning controller generates the cell selection or reselection list based on the first set of information and the second set of information. The cell selection or reselection list comprises a plurality of candidate cells. The cell selection or reselection provisioning controller performs at least one network cell selection or reselection operation based on the cell selection or reselection list.

Conventionally, in the context of NTN cell reselection, it falls upon the UE implementation to assess the cells featured in the SIB4 and SIB19 messages. This evaluation is necessary when discrepancies arise between the neighbor cell list in the SIB4 message and the satellite assistance information in the SIB19 message. Similarly, during the RRC_CONNECTED state, the UE implementation is responsible for selecting cells for the handover procedure from the neighbor cells configured in the RRC measurement and satellite assistance information in an NTN network. It is possible for the UE to choose a subset of cells present in both the SIB4 and SIB19 messages during RRC idle for cell reselection, and a subset of cells present in both the measurement configuration and the SIB19 message during connected state mobility. As a result, the UE may inadvertently move to a weak cell when other, more suitable cells are available, leading to service continuity failure and a negative impact on the user experience.

To ensure seamless NTN cell reselection and handover, the disclosure entails considering all available neighbor cells for the reselection and handover procedure. By doing so, the best-suited NTN cell can be seamlessly accessed in both RRC_IDLE and RRC_CONNECTED states, thereby guaranteeing optimal mobility.

According to one or more embodiments of the disclosure, when a UE is camped on the NTN network and in RRC_IDLE state, it considers all neighbor cells listed in the SIB19 message for cell reselection evaluation, in addition to those listed in SIB4. The UE assigns priorities to the SIB19 message cells with lower priorities than those configured in SIB4. Therefore, these cells are evaluated for cell reselection only if the SIB4 message cells are not suitable. Moreover, if the SIB4 message includes additional cells that are not present in the SIB19 message neighbor cell list, these cells are not ignored for cell reselection evaluation. One or more embodiments of the disclosure also involve the retrieval of satellite assistance information of the cells listed only in the SIB4 message from neighbor UEs through BLE mechanism. This enables the evaluation of all SIB4 message cells for cell reselection.

In NTN networks, when the UE is in RRC_CONNECTED state and the RRC configured cells for handover measurement include cells that are not listed in the SIB19 message neighbor cell list, these cells may not be disregarded for cell sending measurement report. One or more embodiments of the disclosure involve the retrieval of satellite assistance information of the cells present only in measurement objects from neighbor UEs through BLE mechanism. This allows for the evaluation of all RRC configured cells for sending handover measurement report, as per the discretion of UE implementation in accordance with 3GPP standards.

In an embodiment, the UE can retrieve satellite assistance information pertaining to Non-Tracking Area (NTN) cells which are absent in the System Information Block (SIB) 19 message, from a historical database present within the UE. This information can be utilized for both cell reselection and connected state measurements.

One or more embodiments of the disclosure empower the UE to assess all available cells during RRC_IDLE and RRC_CONNECTED state mobility. Thus, the UE, which is camped on the NTN network, may seamlessly transition to the most optimal cell from the entire pool of available cells, during both RRC_IDLE and RRC_CONNECTED state.

One or more embodiments of the disclosure effectively mitigate radio link failures, data stalls, and other issues that commonly arise in weak signal conditions for the UE. This results in a significant enhancement of the user experience for the UE that is camped on the NTN network.

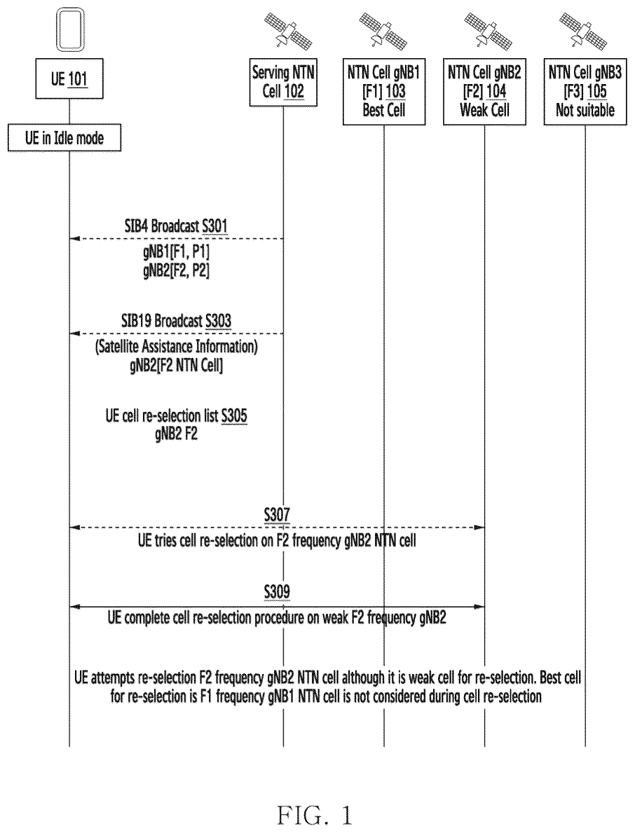

Referring now to the drawings, and more particularly to FIGS. 1 through 21, where similar reference characters denote corresponding features consistently throughout the figures, there are shown embodiments.

FIG. 1 is a sequence diagram that illustrates a conventional improper NTN cell reselection, where the SIB4 message cells are not evaluated during the NTN cell reselection, according to the embodiment disclosed herein. FIG. 1 includes a UE 101, the serving NTN cell 102, cell gNB1 103, cell gNB2 104, cell gNB3 105. The UE 101 is in idle state.

At operation S301, the serving NTN cell SIB4 message broadcast encompasses cell gNB1 103 and cell gNB2 104. It is noted that cell gNB1 103 stands out as the optimal cell for cell reselection.

At operation S303, the SIB19 message exclusively includes information regarding the cell gNB2 104, which is comparatively weaker than the cell gNB1 103.

At operation S305, the UE is limited to selecting cells that are present in both the SIB4 and SIB19 neighbor cell lists. Unfortunately, the cell gNB1 information is absent from the SIB19 message, causing the UE to overlook the cell gNB1 103 for cell reselection. Consequently, the cell selection or reselection list is comprised solely of cell gNB2 104, which is a suboptimal choice.

At operation S307, the UE attempts reselection to the cell gNB2 104. The UE attempts reselection to the cell gNB2 104 although it is weak cell for reselection.

At operation S309, the UE completes cell reselection procedure on weak cell gNB2 104.

The best cell for reselection is the cell gNB1 103, but is not considered during cell reselection since it is not broadcasted in the SIB19 message.

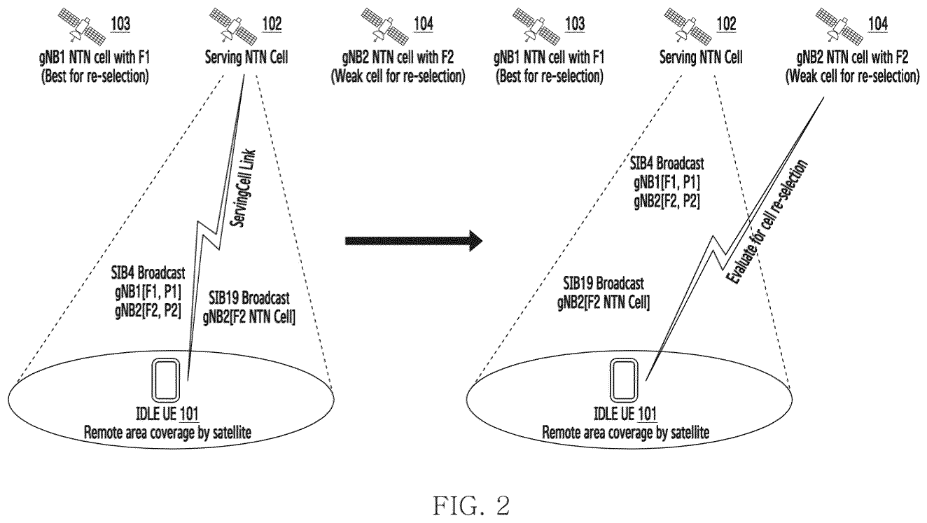

FIG. 2 is a schematic diagram that illustrates the possibility of improper NTN cell reselection, where the SIB4 message cells are not evaluated during the NTN cell reselection. FIG. 2 illustrates that the UE 101 is camped to the serving NTN cell 102 and the UE is in the RRC_IDLE state. The cell gNB2 104 is present in both the SIB4 message and the SIB19 message neighbor cell list. However, the cell gNB2 104 is a weak cell for cell reselection as compared to the cell gNB1 103. Since this decision is up to the UE implementation, the UE evaluated only the cells present in both the SIB4 message and the SIB19 message i.e. cell gNB2 104 for reselection. Reselection is completed on weak cell gNB2 104 although best suitable cell for reselection is the cell gNB1 103 that is available and configured in the SIB4 message.

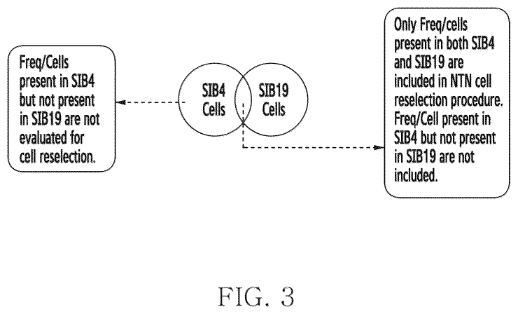

FIG. 3 is a schematic diagram that illustrates the frequencies/cells present in the SIB4 message but not in the SIB19 message. FIG. 3 illustrates that during cell reselection procedure, the UE camped in 5G network utilizes the SIB4 message broadcast information to identify a suitable cell for cell reselection. The SIB4 message broadcast includes neighbor frequencies/cells and associated priorities to assist the UE in reselection procedure. In the NTN networks, the SIB19 message is broadcasted to provide necessary information to the UE about the camped serving NTN cell. Along with other information, the SIB19 message also includes list of neighbor NTN cells to assist the UE to perform optimized mobility measurement. Therefore, in case of the NTN network, for RRC_IDLE state mobility measurements, the UE can acquire the neighbor cell information both from the SIB4 message and the SIB19 message broadcast message.

During the process of cell reselection, the UE uses the information broadcasted in the SIB4 message to identify a suitable cell for reselection. This message includes details of neighboring frequencies and cells, along with their associated priorities, which aid the UE in the reselection procedure. In NTN networks, the SIB19 message is also broadcasted to provide the UE with necessary information about the camped NTN cell. In addition to other pertinent details, the SIB19 message includes a list of neighbor NTN cells that assist the UE in performing optimized mobility measurements. Therefore, in the RRC_IDLE state of mobility measurements in NTN networks, the UE can obtain neighbor cell information from both the SIB4 and SIB19 messages.

The existing 3GPP standards do not mandate that neighboring NTN frequencies/cells and priorities, which are included in the SIB4 message but not in the SIB19 message, must be incorporated for cell reselection evaluation. Therefore, there exists the potential for the UE to disregard or overlook the NTN frequencies/cells present in the SIB4 message that are absent in the SIB19 message during the cell reselection procedure. It is highly plausible that the UE may detect the cells present in the SIB4 message but not in the SIB19 message, which could potentially be the optimal neighboring cells for reselection.

The current implementation of the related art restricts the UE's cell selection to only those cells that are listed in both the SIB4 and SIB19 messages neighbor cell lists. However, this approach may result in the selection of a suboptimal cell during the reselection procedure, if additional cells present in the SIB4 message are better candidates. In cases where no suitable cell is available, the UE may even end up in a no-service state, despite the presence of suitable neighbor cells for reselection. During NTN-NTN mobility, it is critical to evaluate all neighbor NTN cells to identify the best-suited cell, and skipping cells listed in the SIB4 message may lead to the selection of a weak cell or even result in the device moving to a no-service state. This existing implementation thus negatively impacts the service continuity of devices connected to the 5G NTN network, leading to a poor user experience.

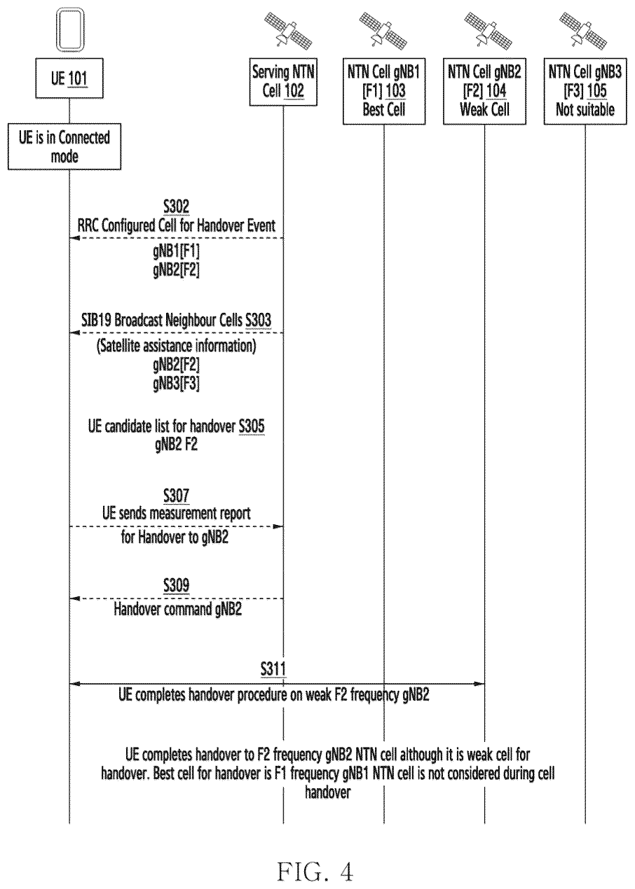

FIG. 4 is a sequence diagram that illustrates a conventional improper NTN handover, where measurement object NTN frequency/cells in the SIB19 message are not measured during handover, according to the embodiment disclosed herein. FIG. 4 includes the UE 101, the serving NTN cell 102, cell gNB1 103, cell gNB2 104, cell gNB3 105. The UE 101 is in connected state.

At operation S302, the serving NTN cell configured RRC reconfiguration message includes cell gNB1 103 and cell gNB2 104. The cell gNB1 103 is best cell for cell reselection.

At operation S303, the SIB19 message includes cell gNB2 104 and cell gNB3 105. The cell gNB2 104 is a weak cell and the cell gNB3 105 is not suitable for reselection.

At operation S305, the existing implementation makes UE 101 to choose only the cells that are present in both RRC reconfiguration message and SIB19 message neighbor cell list. The cell gNB1 103 information is not present in the SIB19 message and UE does not consider the cell gNB1 103 for sending a measurement report. As a result, the cell selection or reselection list for handover consists of only cell gNB2 104. But this is a weak cell.

At operation S307, the UE 101 sends the measurement report for handover to the cell gNB2 104.

At operation S309, the handover command is received from the cell gNB2 104.

At operation S311, the UE 101 completes the handover procedure on the weak cell gNB2 104. The best suitable cell gNB1 103 was not considered for handover as it was not broadcasted in the SIB19 message neighbor cell list.

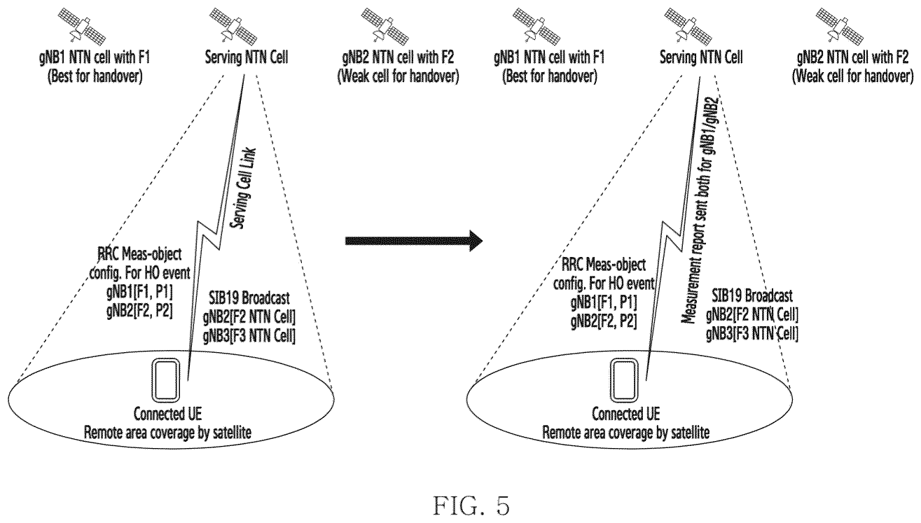

FIG. 5 is a schematic diagram that illustrates the possibility of conventional improper NTN cell handover, where measurement object frequency/cells not present in the SIB19 message gets skipped, according to the embodiment disclosed herein. FIG. 5 illustrates that the UE 101 completes the handover to the cell gNB2 104 although it is weak cell for the handover. The best cell for the handover that is the cell gNB1 103 that is not considered by the UE during the handover process. The best cell gNB1 103 is not considered as the best cell is not broadcasted in the SIB19 message neighbor cell list.

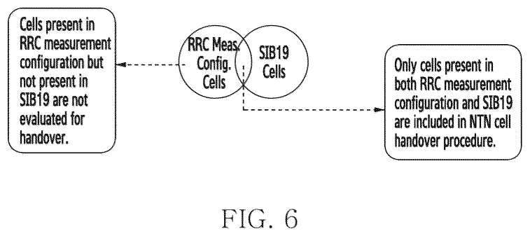

FIG. 6 is a schematic diagram that illustrates the NTN cells present in RRC reconfiguration message but not in the SIB19 message, according to the embodiment disclosed herein. FIG. 6 illustrates that when the UE is camped to the serving NTN cell and is in the RRC_CONNECTED state, the serving NTN cell configures the UE with measurement objects for handover procedure. The UE measures signal level of the configured cells and reports it to the serving NTN cell in the measurement report. After evaluating the measurement reports of the UE, the serving NTN cell provides handover command to the UE for a best suitable cell. On obtaining the handover configurations, the UE utilizes these configurations to move to the best suitable cell in RRC_CONNECTED state.

The current implementation does not mandate for including neighboring NTN cells that are present in handover measurement configurations but not specified in the SIB19 message. This may result in the UE disregarding these cells for measurement evaluation and failing to send measurement reports for them. It is possible that these additional cells, although not mentioned in the SIB19 message, are available to the UE for handover and may even be the most suitable options, taking into account the speed and direction of both the UE and the NTN satellite.

The current approach of the UE, which involves selecting only the cells that appear in both the measurement configuration and the SIB19 message neighbor cell list, may result in the inadvertent exclusion of the most optimal cells for handover. Furthermore, this approach increases the likelihood of the UE being handed over to a weaker cell, which can cause repeated ping-pong effects. Additionally, due to a decline in signal quality, the UE may experience data stalls or even lose connection with the serving NTN cell, resulting in a radio link failure. This existing method significantly impacts service continuity and mobility in the NTN connected state, ultimately leading to a suboptimal user experience for 5G services.

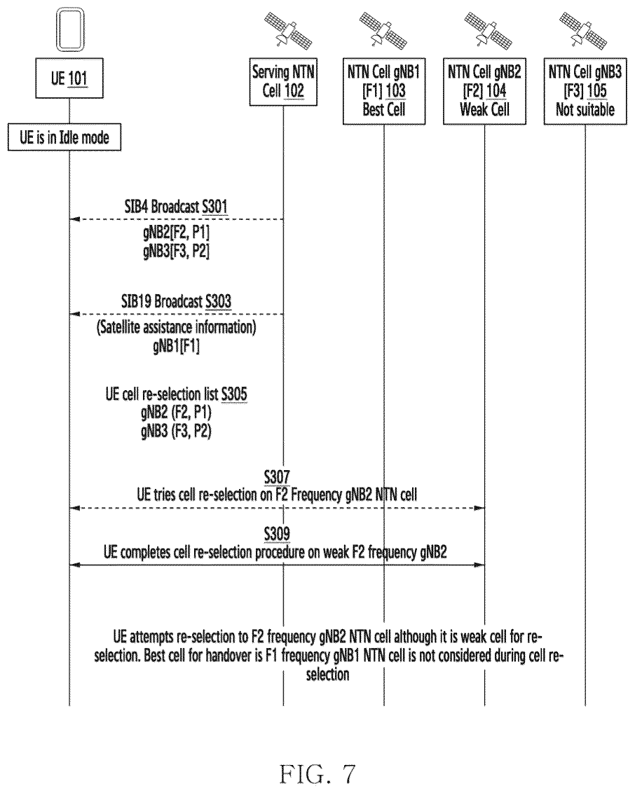

FIG. 7 is a sequence diagram that illustrates a conventional improper NTN cell reselection, where the SIB19 message cells are not evaluated during reselection, according to the embodiment disclosed herein. FIG. 7 includes the UE 101, the serving NTN cell 102, cell gNB1 103, cell gNB2 104 and cell gNB3 105. The UE 101 is in idle state.

At operation S301, the serving NTN cell SIB4 message includes cell gNB2 104 and cell gNB3 105.

At operation S303, the SIB19 message includes cell gNB1 103 which is the best cell for cell reselection.

At operation S305, the cell gNB1 103 information is not present in the SIB4 message and the UE 101 does not consider cell gNB1 103 for cell reselection. As a result, the UE candidate list for cell reselection consists of only cell gNB2 104 and cell gNB3 105. These cells are either weak or not suitable for cell reselection.

At operation S307, the UE 101 tries cell reselection on the cell gNB2 104. The UE 101 attempts cell reselection to cell gNB2 104 although it is weak cell for reselection.

At operation S309, the UE 101 completes the cell reselection on the cell gNB2 104. Since, the cell gNB3 105 is not suitable for cell reselection, the UE attempts reselection to cell gNB2 104. The best suitable cell gNB1 103 is not considered for cell reselection as it is not broadcasted in the SIB4 message.

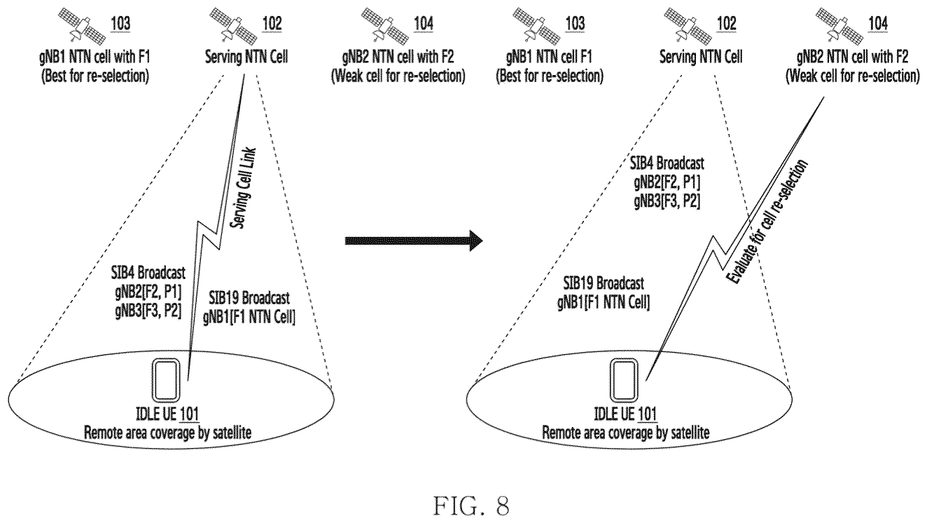

FIG. 8 is a schematic diagram that illustrates the possibility of conventional improper NTN cell reselection, where frequencies/cells present only in the SIB19 message but not present in the SIB4 message are evaluated, according to the embodiment disclosed herein. FIG. 8 illustrates that the UE 101 considers only cell gNB2 104 and cell gNB3 105 for cell reselection. Although cell gNB1 103 is the best suitable for cell reselection, the UE 101 does not consider cell gNB1 103 broadcasted in the SIB19. As a result, the cell reselection to the cell gNB2 104 is attempted and the UE 101 ends up selecting weak cell during cell reselection.

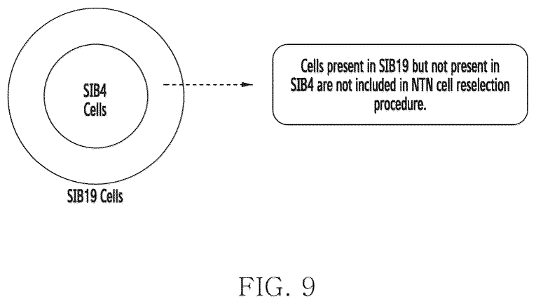

FIG. 9 is a schematic diagram that illustrates the frequencies/cells present only in the SIB19 message but not present in the SIB4 message, according to the embodiment disclosed herein. FIG. 9 illustrates that the network broadcasts the SIB4 message which includes cell details and priorities for cell reselection procedure and the UE has to evaluate cells broadcasted in the SIB4 message information to perform cell reselection procedure. The neighbor cell information is broadcasted only in the SIB4 message in terrestrial networks during idle state and the UE does cell reselection only on the cells broadcasted in the SIB4 message in the order of priority associated with each cell.

The SIB19 message broadcasts neighbor NTN cell information as a component of satellite assistance information, indicating available NTN cells in the network. During cell reselection procedures in NTN networks, the UE prioritizes cells with associated priorities broadcasted in the SIB4 system information message. If neighbor cells or frequencies are present in the SIB19 message but not in the SIB4 message, they have no priority and are not considered for cell reselection. Conforming to 3GPP standards, cells present in the SIB19 message but not in the SIB4 message are restricted and skipped during cell reselection evaluations. Although cells broadcasted solely in satellite assistance information may present opportunities for suitable NTN cell reselection, they are not prioritized in the cell selection process.

In the evaluation of NTN-NTN mobility, the meticulous assessment of NTN cells is of utmost importance in order to identify the most fitting cell. Disregarding the cells conveyed in the SIB19 message may result in the selection of suboptimal cells or even lead to a state of no service for the UE. This current approach adversely affects service continuity and ultimately results in an unsatisfactory user experience for 5G services.

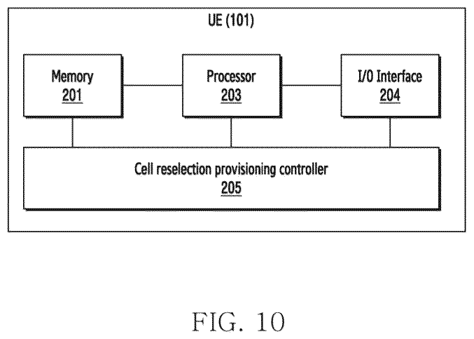

FIG. 10 is a block diagram illustrating various hardware components of the UE for provisioning the cell reselection and connected state measurement in the NTN Networks, according to the embodiment disclosed herein. The UE 101 includes a memory 201, a processor 203, an input/output (I/O) Interface 204, and the cell selection or reselection provisioning controller 205.

With reference to FIG. 10, the UE 101 can encompass a diverse range of devices, including but not limited to laptops, palmtops, desktops, mobile phones, smart phones, Personal Digital Assistants (PDAs), tablets, wearable devices, Internet of Things (IoT) devices, virtual reality devices, Video see-through (VST) AR glasses, foldable devices, flexible devices, display devices, and immersive systems.

Further, the memory 201 of the UE 101 includes storage locations to be addressable through the processor 203. The memory 201 is not limited to a volatile memory and/or a non-volatile memory. Further, the memory 201 can include one or more computer-readable storage media. The memory 201 can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory 201 stores the information of the serving NTN cell. The memory 201 further stores the first set of information and the second set of information comprising cell information, frequency information, and priority information of the candidate cell. The memory 201 also comprises third set of information from at least one neighbor UE associated with the serving NTN cell. The third set of information comprises satellite assistant information of the serving NTN cell, and SIB information associated with the candidate cell.

The processor 203 is configured to execute instructions stored in the memory 201 and to perform various processes. The processor 203 can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The I/O Interface 204 transmits the information between the memory 201 and external peripheral devices. The external peripheral devices are the input-output devices associated with the UE 101. The I/O interface 204 receives the broadcasted information from the serving NTN cell of the UE 101. The information can include but is not limited to the cell information, the frequency information, and the priority information of the plurality of candidate cells. The information may also include the satellite assistant information of the serving NTN cell, and the SIB information associated with the candidate cell.

The cell selection or reselection provisioning controller 205 is an innovative hardware that is realized through the physical implementation of both analog and digital circuits, including logic gates, integrated circuits, microprocessors, microcontrollers, memory circuits, passive and active electronic components, as well as optical components.

The cell selection or reselection provisioning controller 205 camps the UE 101 on the serving NTN cell in the NTN. The cell selection or reselection provisioning controller 205 receives the first message comprising the first set of information and the second message comprising the second set of information broadcasted by the serving NTN cell. The second set of information is one of completely different information or partially different information from the first set of information. Further, the cell selection or reselection provisioning controller 205 generates the cell selection or reselection list based on the first set of information and the second set of information. The cell selection or reselection list comprises a plurality of candidate cells. The cell selection or reselection provisioning controller 205 performs at least one network cell selection or reselection operation based on the cell selection or reselection list.

In an embodiment, the first message is a first SIB message and the second message is a second SIB message, when the UE is in an idle state.

For example, the first SIB message can be the SIB4 message and the second SIB message can be the SIB19 message.

In an embodiment, the first message is a RRC reconfiguration message and the second message is a second SIB message, when the UE is in connected state.

In an embodiment, the first set of information comprises cell information of at least one first candidate cells of the plurality of candidate cells. The first set of information further comprises at least one of at least one frequency information of at least one candidate cell of the plurality of candidate cells, and priority information of the at least one candidate cell.

In an embodiment, the completely different information or the partially different information in the second set of information comprises at least one of cell information of at least one second candidate cell of the plurality of candidate cells. The second set of information further comprises satellite assistant information, at least one frequency information of the at least one second candidate cell of the plurality of candidate cells, and priority information of the at least one second candidate cell.

In an embodiment, the UE 101 generates the cell selection or reselection list based on the first set of information and the second set of information. The cell selection or reselection list generation comprises receiving a third message comprising a third set of information from at least one neighbor UE associated with the serving NTN cell by the UE 101. The third message comprises at least one of satellite assistant information of the serving NTN cell, and SIB information associated with at least one candidate cell from the plurality of candidate cells. The UE 101 further generates the cell selection or reselection list by mapping the first set of information and the second set of information with the third set of information.

In an embodiment, the third message is received through a short-range communication between the UE and the neighbor UEs associated with the serving NTN cell.

In an embodiment, the UE 101 performs at least one network cell selection or reselection operation based on the cell selection or reselection list. A first cell selection or reselection operation comprises selecting an optimal candidate cell from the cell selection or reselection list by the UE 101. A second cell selection or reselection operation comprises performing measurements of at least one candidate cell from the plurality of candidate cells and selecting by the UE 101 an optimal candidate cell from the cell selection or reselection list based on the measurements. The second cell selection or reselection operation further comprises sending a measurement report comprising the measurements to the optimal candidate cell and receiving a handover command from the optimal candidate cell by the UE 101. The second cell selection or reselection operation also comprises performing by the UE 101 a handover procedure on an optimal frequency associated with the optimal candidate cell. The third cell selection or reselection operation comprises selecting by the UE 101 an optimal candidate cell from the cell selection or reselection list. The third cell selection or reselection operation further comprises selecting an optimal frequency of at least one candidate cell from the plurality of candidate cells for cell selection or reselection by the UE 101.

In an embodiment, the UE 101 selects an optimal candidate cell from the cell selection or reselection list. The UE 101 assigns a first priority to at least one first candidate cells and a second priority to at least one second candidate cells in the cell selection or reselection list. The at least one first candidate cells are retrieved from the first set of information and wherein the at least one second candidate cells are retrieved from the second set of information. The second priority is lower than the first priority.

In an embodiment, the UE 101 selects the optimal candidate cell from the at least one first candidate cells. Further, the UE 101 evaluates the at least one first candidate cells based on the first priority and a third set of information received from at least one neighbor UE associated with the serving NTN cell.

In an embodiment, the UE 101 selects the optimal candidate cell from the at least one second candidate cells. Further, the UE 101 evaluates the at least one second candidate cells based on the second priority and a third set of information received from at least one neighbor UE associated with the serving NTN cell. The UE 101 performs the evaluation when the at least one first candidate cells are not the optimal candidate cell.

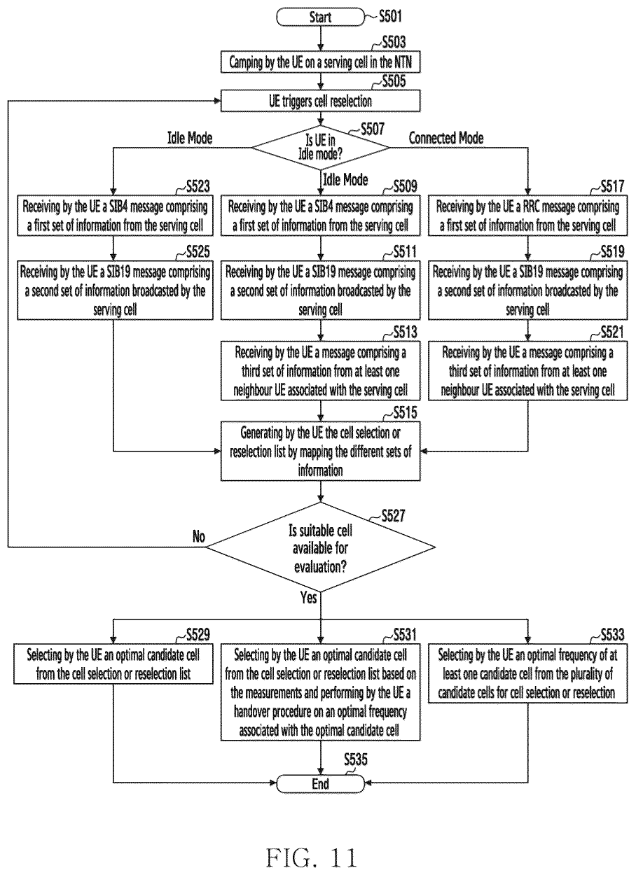

FIG. 11 is a flowchart that illustrates a method for provisioning cell selection or reselection in the NTN by the UE. At operation S501, the UE starts the cell selection or reselection procedure.

Upon reaching operation S503, the UE gracefully establishes its presence on the serving NTN cell within the NTN. Moving on to operation S505, the UE then initiates the cell selection or reselection process with finesse. Finally, at operation S507, the UE astutely discerns whether it is in an idle state or a connected state.

In an embodiment, at operation S509, if the UE is in idle state, it receives the SIB4 message comprising the first set of information broadcasted by the serving NTN cell. The first set of information comprises cell information of at least one first candidate cells of the plurality of candidate cells. The first set of information further comprises at least one of at least one frequency information of at least one candidate cell of the plurality of candidate cells, and priority information of the at least one candidate cell.

At operation S511, the UE is presented with the SIB19 message including the second set of information disseminated by the serving NTN cell. This set of information is distinct from the first set, either partially or entirely. The second set encompasses cell information pertaining to at least one candidate cell from among the plurality of candidates. Additionally, it includes satellite assistant information, frequency information, and priority information related to the same candidate cell(s).

At operation S513, the UE receives a third message comprising a third set of information from at least one neighbor UE associated with the serving NTN cell. The third message comprises at least one of satellite assistant information of the serving NTN cell, and SIB information associated with at least one candidate cell from the plurality of candidate cells.

In an embodiment, the third message is received through a short-range communication between the UE and the neighbor UEs associated with the serving NTN cell.

At operation S515, the UE generates the cell selection or reselection list by mapping the first set of information, the second set of information and the third set of information.

At operation S527, since all the SIB4 message cells are also included along with the SIB19 message cells as candidate cells for reselection, the UE evaluates best suitable cell among all available cells.

In an embodiment, at operation S517, when the UE is in connected state, it receives the RRC reconfiguration message comprising the first set of information broadcasted by the serving NTN cell. The first set of information comprises cell information of at least one first candidate cells of the plurality of candidate cells. The first set of information further comprises at least one of at least one frequency information of at least one candidate cell of the plurality of candidate cells, and priority information of the at least one candidate cell.

At operation S519, the UE receives the SIB19 message comprising the second set of information broadcasted by the serving NTN cell. The second set of information is completely different information or the partially different information compared to the first set of information. The second set of information comprises at least one of cell information of at least one second candidate cell of the plurality of candidate cells. The second set of information further comprises satellite assistant information, at least one frequency information of the at least one second candidate cell of the plurality of candidate cells, and priority information of the at least one second candidate cell.

At operation S521, the UE receives a third message comprising a third set of information from at least one neighbor UE associated with the serving NTN cell. The third message comprises at least one of satellite assistant information of the serving NTN cell, and SIB information associated with at least one candidate cell from the plurality of candidate cells.

In an embodiment, the third message is received through a short-range communication between the UE and the neighbor UEs associated with the serving NTN cell.

At operation S515, the UE generates the cell selection or reselection list by mapping the first set of information, the second set of information and the third set of information.

At operation S527, the UE evaluates all the configured cells for sending the measurement report.

In an embodiment, at operation S523, if the UE is in idle state, it receives the SIB4 message comprising the first set of information broadcasted by the serving NTN cell. The first set of information comprises cell information of at least one first candidate cells of the plurality of candidate cells. The first set of information further comprises at least one of at least one frequency information of at least one candidate cell of the plurality of candidate cells, and priority information of the at least one candidate cell.

At operation S525, the UE receives the SIB19 message comprising the second set of information broadcasted by the serving NTN cell. The second set of information is completely different information or the partially different information compared to the first set of information. The second set of information comprises at least one of cell information of at least one second candidate cell of the plurality of candidate cells. The second set of information further comprises satellite assistant information, at least one frequency information of the at least one second candidate cell of the plurality of candidate cells, and priority information of the at least one second candidate cell.

At operation S515, the UE generates the cell selection or reselection list by mapping the first set of information and the second set of information.

At operation S527, since all the SIB19 message cells are also included along with the SIB4 message cells as candidate cells for reselection, the UE evaluates the best suitable cell among all available cells.

In an embodiment, at operation 529, the UE selects an optimal candidate cell from the cell selection or reselection list.

In an embodiment, at operation 531, the UE performs measurements of at least one candidate cell from the plurality of candidate cells. Further, the UE selects an optimal candidate cell from the cell selection or reselection list based on the measurements and sends the measurement report comprising the measurements to the optimal candidate cell. The optimal candidate cell transmits the handover command to the UE. When the handover command is received, the UE performs the handover procedure on an optimal frequency associated with the optimal candidate cell.

In an embodiment, at operation 533, the UE selects an optimal candidate cell from the cell selection or reselection list. Further, the UE selects an optimal frequency of at least one candidate cell from the plurality of candidate cells for cell selection or reselection.

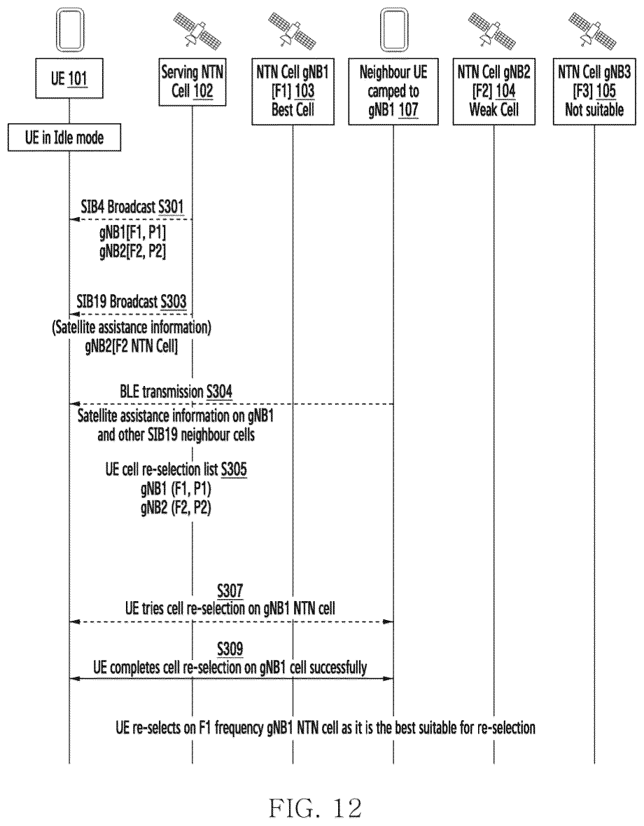

FIG. 12 is a sequence diagram that illustrates acquiring the SIB19 message information of the neighbor UE through the BLE mechanism to use during cell reselection, according to the embodiment disclosed herein. FIG. 12 includes the UE 101, the serving NTN cell 102, cell gNB1 103, cell gNB2 104, cell gNB3 105 and a neighbor UE 107 camped to the gNB1 103. The UE 101 is in idle state.

At operation S301, the serving NTN cell SIB4 message includes cell gNB1 103 and cell gNB2 104. The cell gNB1 103 is the best cell for cell reselection.

At operation S303, the SIB19 message includes only cell gNB2 104 which is a weaker cell compared to the cell gNB1 103.

At operation S304, the UE 101 acquires required cell gNB1 103 satellite information from the neighbor UE through the short-range communication.

At operation S305, in some embodiments, cell gNB1 103 information broadcasted in the SIB4 message is also considered for cell reselection although it is not present the SIB19 message. As a result, the cell selection or reselection list includes cell gNB1 103 and cell gNB2 104.

At operation S307, since cell gNB1 103 is present in the cell selection or reselection list and it is the best suitable cell for cell reselection, the UE 101 attempts reselection on the cell gNB1 103.

At operation S309, the UE 101 completes cell reselection procedure on the best suitable cell gNB1 103.

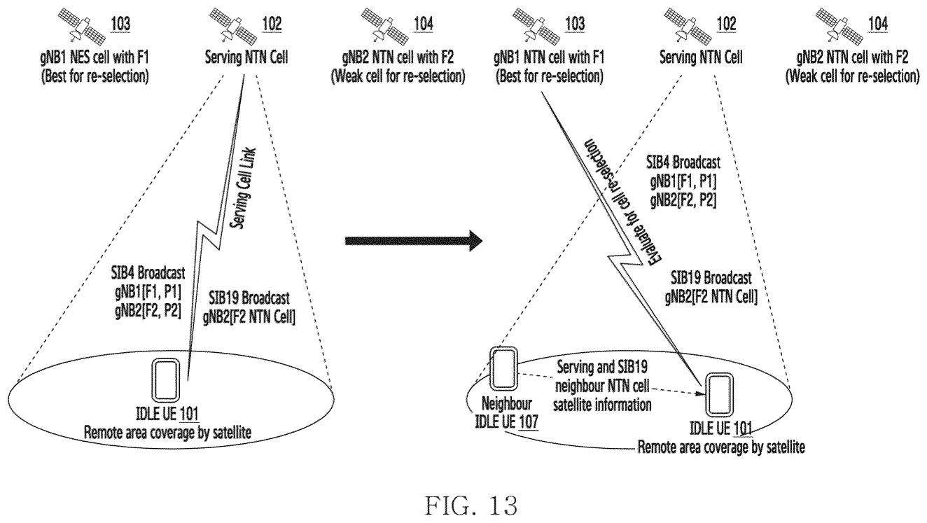

FIG. 13 is a schematic diagram that illustrates acquiring the SIB19 message information of the neighbor UE through the BLE mechanism to use during cell reselection, according to the embodiment disclosed herein. FIG. 13 illustrates the UE 101 that is camped to the serving NTN cell 102 and the UE is in the idle state. The cell gNB2 104 is present in both the SIB4 message and the SIB19 message neighbor cell list. However, the cell gNB2 104 is a weak cell for cell reselection as compared to the cell gNB1 103. The cell gNB1 103 for which the information is broadcasted in the SIB4 message is also considered for cell reselection although it is not present in the SIB19 message. As a result, the cell selection or reselection list includes the cell gNB1 103 and the cell gNB2 104. Since the cell gNB1 103 is present in the cell selection or reselection list and it is the best suitable cell for cell reselection, the UE 101 attempts reselection on the cell gNB1 103. The UE 101 completes cell reselection procedure on the best suitable cell gNB1 103.

The UE evaluates all the cells present in the SIB4 message but not present in the SIB19 message during NTN cell reselection procedure. With this approach the UE evaluates all the cells present in the SIB4 message regardless of whether or not that cell is present in the SIB19 message. For the UE to evaluate a NTN cell, it needs satellite assistance information of that NTN cell. The satellite assistance information such as epoch time, validity duration for uplink synchronization in NTN access, cell-specific K offset (e.g., Scheduling offset used in the timing relationships in NTN), K offset related to medium access control (MAC) control element (CE), polarization information for downlink, polarization information for uplink, timing advance (TA) information, information for indicating whether TA report is enabled or not, ephemeris information etc., are provided to the UE in the SIB19 message. However, in this case, the UE does not have the satellite assistance information of the cells present in the SIB4 message but not present in the SIB19 message. Therefore, the UE acquires satellite assistance information from the neighbor UEs camped in the NTN network through BLE mechanism. Using the BLE mechanism, the UE acquires required information from the neighbor UEs through short-range communication.

For example, the short-range communication can be one of a Bluetooth low energy (BLE) communication, a near-field communication (NFC) or a ZigBee communication or any similar communication.

The satellite assistance information of the serving NTN cell and the neighbor NTN cell list in the SIB19 message of neighbor UE is retrieved through the BLE mechanism. This satellite assistance information is mapped with the cells present in the SIB4 message but not in the SIB19 message to perform measurement on the cells during cell reselection.

In an embodiment, the UE acquires satellite assistance information of the neighbor UEs serving NTN cell through BLE mechanism. Apart from this, neighbor NTN cell list information present in the SIB19 message of the neighbor UEs is also acquired by the UE through BLE mechanism.

In some embodiments, the UE may have all neighbor satellite information associated with cells broadcasted in the SIB4 message which are used to measure and evaluate cells present in the SIB4 message but not present in the SIB19 message during NTN cell reselection procedure. The UE choose the best cell from the candidate cell list and ensures service continuity.

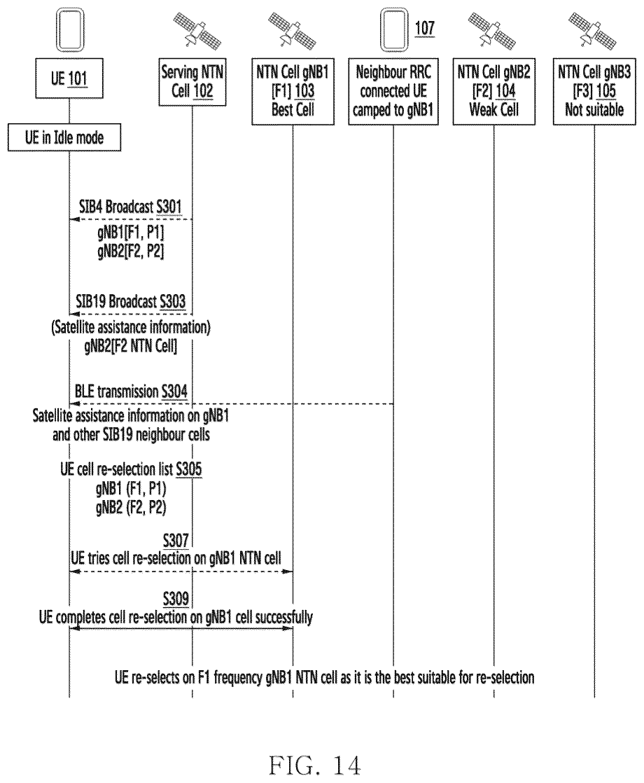

FIG. 14 is a sequence diagram that illustrates operations for acquiring neighbor cell information in RRC reconfiguration of neighbor UE through BLE mechanism, according to the embodiment disclosed herein. FIG. 14 includes the UE 101, the serving NTN cell 102, cell gNB1 103, cell gNB2 104, cell gNB3 105 and a neighbor RRC connected UE 107 camped to the gNB1 103. The UE 101 is in idle state.

At operation S301, the serving NTN cell SIB4 message includes cell gNB1 103 and cell gNB2 104. The cell gNB1 103 is the best cell for cell reselection.

At operation S303, the SIB19 message includes only cell gNB2 104 which is a weaker cell compared to the cell gNB1 103.

At operation S304, the UE 101 acquires satellite assistance information on cell gNB1 103 and the other SIB19 message neighbor cells through the neighbor UE using short-range communication.

At operation S305, in some embodiments, cell gNB1 103 information broadcasted in the SIB4 message is also considered for cell reselection although it is not present the SIB19 message. As a result, the cell selection or reselection list includes cell gNB1 103 and cell gNB2 104.

At operation S307, since cell gNB1 103 is present in the cell selection or reselection list and it is the best suitable cell for cell reselection, the UE 101 attempts reselection on the cell gNB1 103.

At operation S309, the UE 101 completes cell reselection procedure on the best suitable cell gNB1 103.

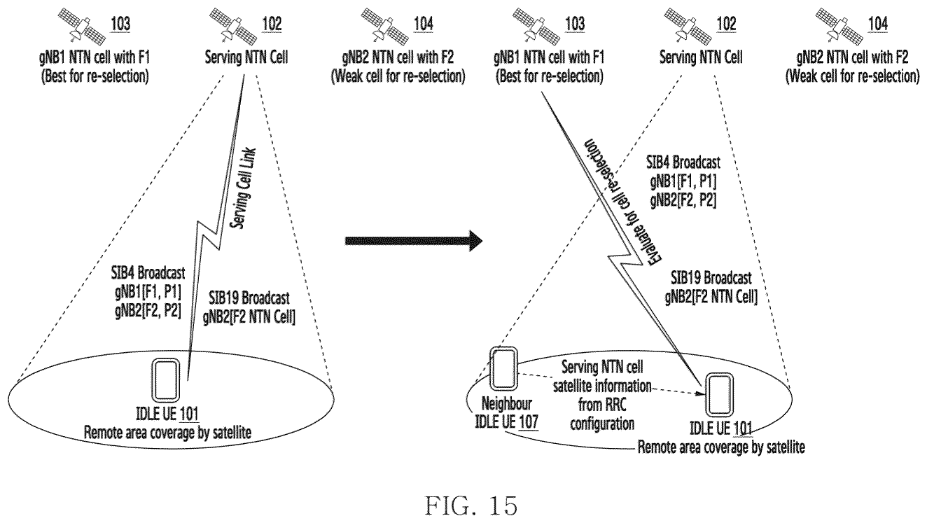

FIG. 15 is a schematic diagram that illustrates acquiring neighbor cell information in RRC reconfiguration of neighbor UE through BLE mechanism, according to the embodiment disclosed herein. FIG. 15 illustrates the UE 101 that is camped to the serving NTN cell 102 and the UE is in the idle state. The cell gNB2 104 is present in both the SIB4 message and the SIB19 message neighbor cell list. However, the cell gNB2 104 is a weak cell for cell reselection as compared to the cell gNB1 103. The cell gNB1 103 for which the information is broadcasted in the SIB4 message is also considered for cell reselection although it is not present in the SIB19 message. As a result, the cell selection or reselection list includes the cell gNB1 103 and the cell gNB2 104. Since the cell gNB1 103 is present in the cell selection or reselection list and it is the best suitable cell for cell reselection, the UE 101 attempts the reselection on the cell gNB1 103. The UE 101 completes cell reselection procedure on the best suitable cell gNB1 103.

In an embodiment, the UE evaluates cells present in the SIB4 message but not present in the SIB19 message during NTN cell reselection procedure. For the UE to measure/evaluate the NTN cell, it needs satellite assistance information of that NTN cell. The satellite assistance information such as epoch time, validity duration for uplink synchronization in NTN access, cell-specific K offset (e.g., Scheduling offset used in the timing relationships in NTN), K offset related to medium access control (MAC) control element (CE), polarization information for downlink, polarization information for uplink, timing advance (TA) information, information for indicating whether TA report is enabled or not, ephemeris information etc., are provided to the UE in the SIB19 message. However, in this case, the UE does not have the satellite assistance information of the cells present in the SIB4 as these are not present in the SIB19 message. The UE acquires this information from the neighbor UEs registered in the NTN network in the connected state through BLE mechanism.

For the UE in RRC_CONNECTED state, network provides satellite information of the neighbor cells in RRC reconfiguration message. The “OtherConfig” information element in RRC configuration message includes satellite information such as ‘epochTime’, ‘ephemerisInfo’ of the neighbor cells which can be used for the measurements of the NTN cells. These satellite information of the neighbor cells present in the neighbor UEs can be acquired by the UE through BLE mechanism. Using this information, the UE can measure additional cells present in the SIB4 message but not present in the SIB19 message for cell reselection procedure.

The UE acquires satellite information from the neighbor RRC_CONNECTED UEs and performs mapping the satellite assistance information of neighbor NTN cells with the cell list of cells included in the SIB4 message and missing in the SIB19 message.

In an embodiment, the UE retrieves the satellite assistance information of the NTN cells included in the SIB4 message but not present in the SIB19 message from the database history available in the UE and is used for cell reselection.

As a result, the UE may have all the neighbor NTN satellite information which can be used to measure and evaluate cells present in the SIB4 message but not present in the SIB19 message during NTN cell reselection procedure. Thus, all the cells in the SIB4 message becomes candidate cells for the cell reselection.

TABLE 1
SIB4 Broadcast Cells

| Cells/Frequencies | Priority |
|---|---|
| gNB1/F1 | P1 |
| gNB2/F2 | P2 |
| gNB3/F3 | P3 |
| gNB4/F4 | P4 |
| gNB5/F5 | P5 |

TABLE 2
SIB19 Broadcast Cells

Cells/Frequencies
gNB3/F3
gNB4/F4
gNB5/F5

TABLE 3
UE Cell Selection or Reselection List

| | | |
|---|---|---|
| Cells/Frequencies | Signal Level | Priority |

| | | | |
|---|---|---|---|
| gNB1/F1 | −88 | dBm | P1 |
| gNB2/F2 | −92 | dBm | P2 |
| gNB3/F3 | −118 | dBm | P3 |
| gNB4/F4 | −119 | dBm | P4 |

| | | |
|---|---|---|
| gNB5/F5 | <Not Found> | P5 |

For example, the Table 1 indicates the SIB4 broadcast cells and the Table 2 indicates the SIB19 broadcast cells. The Table 3 indicates the cell selection or reselection list. The cell selection or reselection list considers both SIB4 broadcasted cell and SIB19 broadcasted cells for NTN reselection procedure. Therefore, if a cell is present in the SIB4 message but not in the SIB19 message, it is evaluated for reselection. Since cell gNB1 is more suitable based on power level, device successfully completes reselection on gNB1 and remain in service.

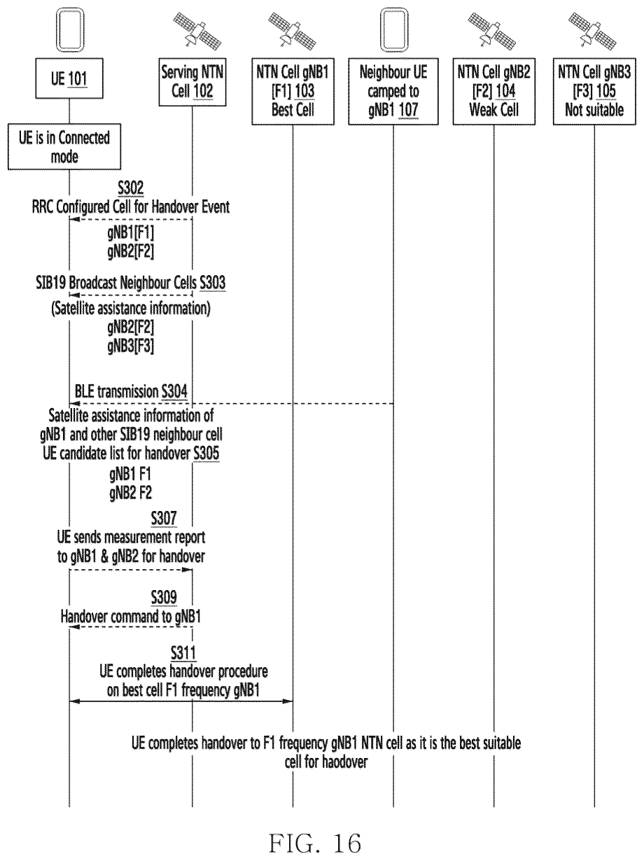

FIG. 16 is a sequence diagram that illustrates acquiring the SIB19 message information of the neighbor UE through the BLE mechanism to use during the connected state measurements, according to the embodiment disclosed herein. FIG. 16 includes the UE 101, the serving NTN cell 102, cell gNB1 103, cell gNB2 104, cell gNB3 105 and the neighbor UE 107 camped to the gNB1 103. The UE 101 is in connected state.

At operation S302, the RRC reconfiguration message includes the cell gNB1 103 and cell gNB2 104. The cell gNB1 103 is the best cell for cell reselection.

At operation S303, the SIB19 message includes the cell gNB2 104 and the cell gNB3 105. The cell gNB2 104 is a weaker cell compared to the cell gNB1 103 and the cell gNB3 105 is not suitable for the handover.

At operation S304, the UE 101 acquires satellite assistance information on the cell gNB1103 and the other SIB19 message neighbor cells through the neighbor UE using short-range communication.

At operation S305, in some embodiments, the cell gNB1 103 configured in RRC reconfiguration message for handover event measurement is also considered as the candidate cell. As a result, the cell selection or reselection list includes the cell gNB1 103 and the cell gNB2 104.

At operation S307, the UE 101 sends the measurement report to both cell gNB1 103 and cell gNB2 104.

At operation S309, since cell gNB1 103 is present in the cell selection or reselection list and it is the best suitable cell for handover, the network sends the handover command to the cell gNB1 103.

At operation S311, the UE 101 completes the handover to the best suitable cell gNB1 103 successfully.

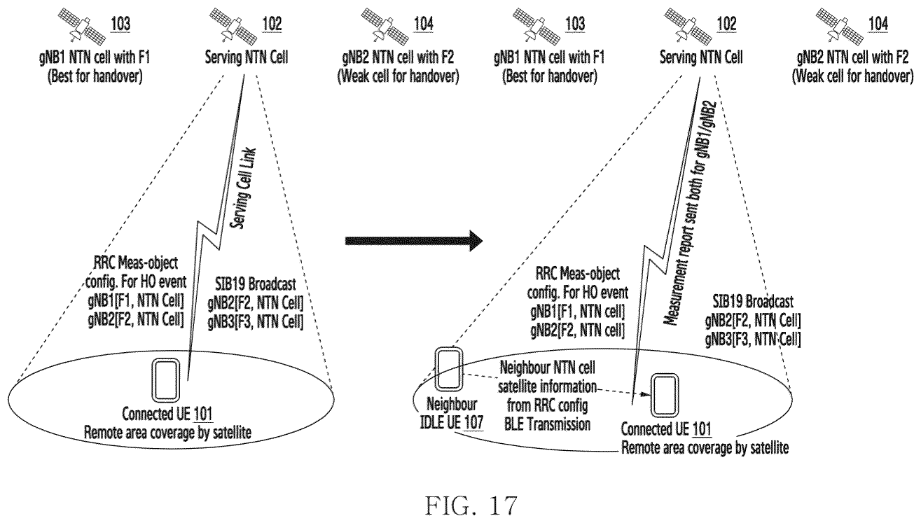

FIG. 17 is a schematic diagram that illustrates operations for acquiring the SIB19 message information of the neighbor UE through the BLE mechanism to use during the connected state measurements, according to the embodiment disclosed herein. FIG. 17 illustrates the UE 101 that is camped to the serving NTN cell 102 and the UE 101 is in the connected state. The cell gNB2 104 is present in both the RRC reconfiguration message and the SIB19 message neighbor cell list. However, the cell gNB2 104 is a weak cell for handover as compared to the cell gNB1 103. The cell gNB1 103 for which the information is broadcasted in the RRC reconfiguration message is also considered for handover although it is not present in the SIB19 message. As a result, the cell selection or reselection list includes the cell gNB1 103 and the cell gNB2 104. Since the cell gNB1 103 is present in the cell selection or reselection list, the UE 101 sends the measurement report for both cell gNB1 103 and cell gNB2 104. The cell gNB1 103 is the best suitable cell for handover, the network sends the handover command to the cell gNB1 103. Thus, the UE 101 completes the handover to the best suitable cell gNB1 103 successfully.

In an embodiment, the UE evaluates the cells present in the RRC reconfiguration message but not present in the SIB19 message during NTN handover procedure. With this approach UE evaluates all the cells present in the RRC reconfiguration message regardless of whether or not this cell is present in the SIB19 message. For a UE to measure the NTN cell, it needs satellite assistance information of that NTN cell. The satellite assistance information such as epoch time, ephemeris information etc., are provided to the UE in the SIB19 message. However, in this case, the UE does not have the satellite assistance information of the cells present in the RRC reconfiguration message but not present in the SIB19 message. So, the UE acquires this satellite information from the neighbor UEs camped in the NTN network through the BLE mechanism.

Using BLE mechanism, the UE can acquire required information from the neighbor UEs through Bluetooth transmission. The UE acquires the serving NTN cell satellite assistance information of the neighbor UEs through BLE mechanism.

The satellite assistance information of the serving NTN cell and the neighbor NTN cell list in the SIB19 message of the neighbor UE is retrieved through the BLE mechanism. This satellite assistance information is utilized to measure the cells present in the RRC reconfiguration message but not present in the SIB19 message. According to the embodiments, the UE acquires satellite assistance information of the neighbor UEs serving NTN cell through BLE mechanism. Apart from this, neighbor NTN cell list information present in the SIB19 message of the neighbor UEs is also acquired by the UE through the BLE mechanism.

According to the embodiments, the UE has all neighbor satellite information which is used to measure and evaluate cells present in the RRC reconfiguration message but not present in the SIB19 message during the NTN handover procedure. In some embodiments, the UE chooses best cell by making more numbers of candidate cell list and ensures service continuity in connected state mobility.

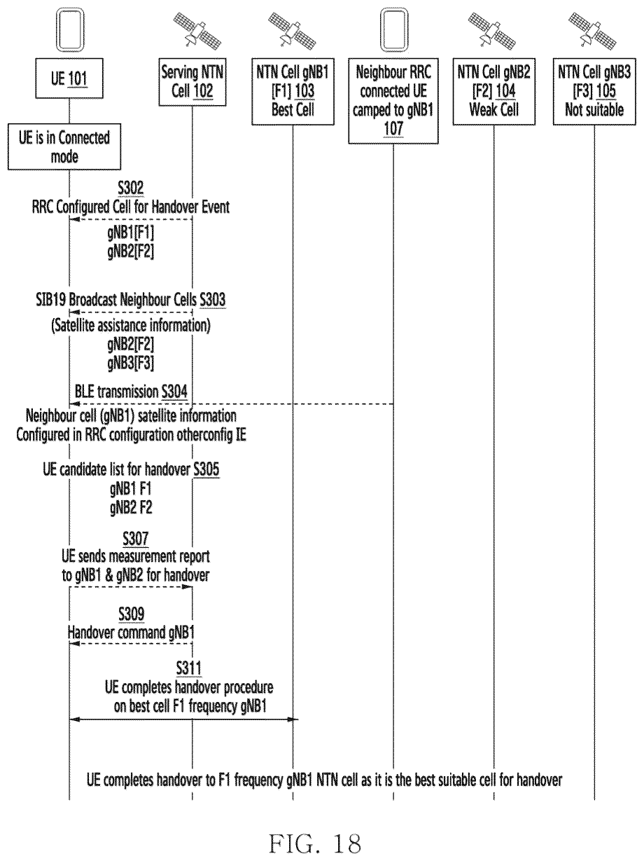

FIG. 18 is a sequence diagram that illustrates all measurement object cells are measured during handover, according to the embodiment disclosed herein. FIG. 18 includes the UE 101, the serving NTN cell 102, cell gNB1 103, cell gNB2 104, cell gNB3 105 and the neighbor RRC connected UE 107 camped to the gNB1 103. The UE 101 is in connected state.

At operation S302, the RRC reconfiguration message includes the cell gNB1 103 and cell gNB2 104. The cell gNB1 103 is the best cell for cell reselection.

At operation S303, the SIB19 message includes the cell gNB2 104 and the cell gNB3 105. The cell gNB2 104 is a weaker cell compared to the cell gNB1 103 and the cell gNB3 105 is not suitable for the handover.

At operation S304, the UE 101 acquires the cell gNB1 103 satellite information from the neighbor RRC connected UE using the short-range communication. The cell gNB1 103 is a neighbor RRC connected UEs neighbor cell.

At operation S305, in some embodiments, the cell gNB1 103 configured in RRC reconfiguration message for handover event measurement is also considered as the candidate cell. As a result, the cell selection or reselection list includes the cell gNB1 103 and the cell gNB2 104.

At operation S307, the UE 101 sends the measurement report to both cell gNB1 103 and cell gNB2 104.

At operation S309, since the cell gNB1 103 is present in the cell selection or reselection list and it is the best suitable cell for handover, the network sends the handover command to the cell gNB1 103.

At operation S311, the UE 101 completes the handover to the best suitable cell gNB1 103 successfully.

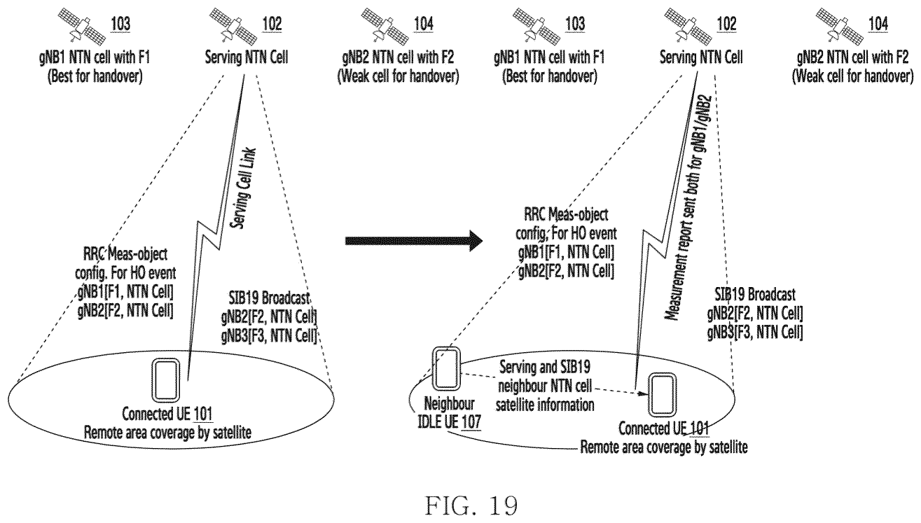

FIG. 19 is a schematic diagram that illustrates all measurement object cells are measured during handover, according to the embodiment disclosed herein. FIG. 19 illustrates the UE 101 that is camped to the serving NTN cell 102 and the UE 101 is in the connected state. The cell gNB2 104 is present in both the RRC reconfiguration message and the SIB19 message neighbor cell list. However, the cell gNB2 104 is a weak cell for handover as compared to the cell gNB1 103. The cell gNB1 103 for which the information is broadcasted in the RRC reconfiguration message is also considered for the handover although it is not present in the SIB19 message. The UE 101 acquires the cell gNB1 103 satellite information from the neighbor RRC connected UE using the short-range communication. The cell gNB1 103 is a neighbor RRC connected UEs neighbor cell. As a result, the cell selection or reselection list includes the cell gNB1 103 and the cell gNB2 104. Since the cell gNB1 103 is present in the cell selection or reselection list, the UE 101 sends the measurement report for both the cell gNB1 103 and the cell gNB2 104. The cell gNB1 103 is the best suitable cell for handover, the network sends the handover command to the cell gNB1 103. Thus, the UE 101 completes the handover to the best suitable cell gNB1 103 successfully.

In an embodiment, the UE assesses cells that are included in the RRC reconfiguration message but not in the SIB19 message during the NTN handover procedure. To measure the NTN cell, the UE requires satellite assistance information specific to that cell, such as epoch time and ephemeris information, which is typically provided in the SIB19 message. However, in this scenario, the UE lacks the satellite assistance information for cells present in the RRC reconfiguration message but not in the SIB19 message. Nevertheless, for the UE in RRC_CONNECTED state, the network furnishes the satellite information of the neighboring cells in the RRC reconfiguration message.

The “OtherConfig” information element in the RRC reconfiguration message includes satellite information such as ‘epochTime’, ‘ephemerisInfo’ etc., of the neighbor cells. According to one or more embodiments, the UE utilizes this neighbor cell information provided in the RRC reconfiguration message to measure the cells present in the RRC reconfiguration message but not present in the SIB19 message.

Additionally, the UE acquires this neighbor cell information from the neighbor UEs registered in the NTN network and stays in connected state through the BLE mechanism. So, the UE acquires the required satellite assistance information from the neighbor UEs through the BLE mechanism for cells present in the RRC reconfiguration message but not present in the SIB19 message.

The satellite information of the neighbor cells present in the otherconfig IE of RRC configuration which is obtained from its own RRC Reconfiguration or retrieved from neighbor UE through BLE mechanism can be used to map with NTN cells present in measurement objects but not in the SIB19 message and can be used to perform the neighbor cells measurement of those NTN cells.

In an embodiment, the UE can retrieve satellite assistance information of the NTN cells included in RRC reconfiguration message but not present in the SIB19 message from the database history available in the UE and can be used for the connected state measurements. As a result, the UE have all neighbor NTN satellite information which can be used to measure and evaluate cells present in the RRC reconfiguration message but not present in the SIB19 message during NTN handover procedure.

TABLE 4
RRC Configured Cells for Handover

Cells/Frequencies
gNB2/F2
gNB3/F3
gNB4/F4

TABLE 5
SIB19 Broadcast Cells

Cells/Frequencies
gNB1/F1
gNB2/F2

TABLE 6
UE Cell selection or Reselection List for Handover

| Cells/Frequencies | Signal Level | |
|---|---|---|
| gNB2/F2 | −110 | dBm |
| gNB3/F3 | −88 | dBm |

| | |
|---|---|
| gNB4/F4 | <Not Found> |

For example, the Table 4 indicates the RRC configured cells for handover and the Table 2 indicates the SIB19 broadcast cells. The Table 3 indicates the cell selection or reselection list for handover. The cell selection or reselection list considers all RRC configured cells for handover evaluation since it is up to the UE implementation. Therefore, among the configured cells, the UE evaluates and sends measurement report for all the best suitable cells. Since, cell gNB3 is more suitable based on power level, the UE successfully completes handover on the cell gNB3 and remains in stable service.

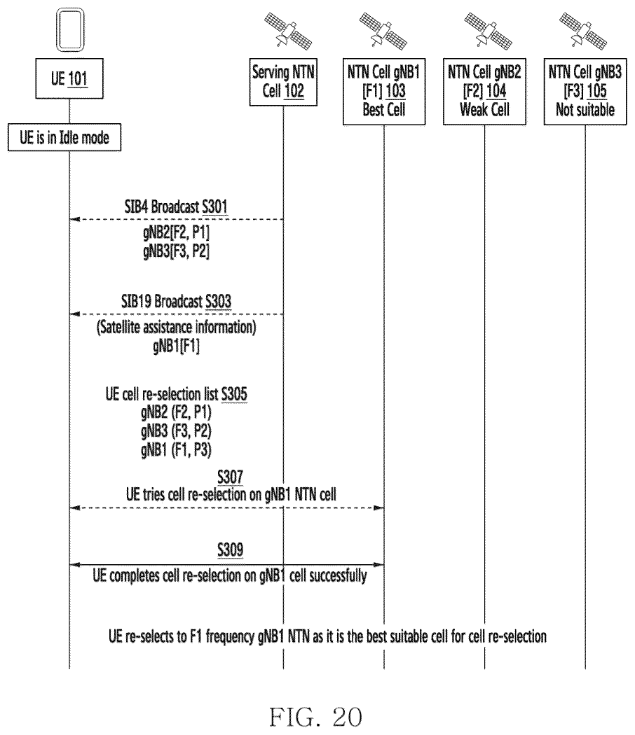

FIG. 20 is a sequence diagram that illustrates the SIB19 message cells evaluated during NTN cell reselection, according to the embodiment disclosed herein. FIG. 20 includes the UE 101, the serving NTN cell 102, cell gNB1 103, cell gNB2 104 and cell gNB3 105. The UE 101 is in idle state.

At operation S301, the serving NTN cell SIB4 message includes cell gNB2 104 and cell gNB3 105.

At operation S303, the SIB19 message includes cell gNB1 103 which is the best cell for cell reselection.

At operation S305, in some embodiments, the cell gNB1 103 information broadcasted in the SIB19 message is also considered for cell reselection. As a result, the UE candidate list for cell reselection includes cell gNB2 104, cell gNB3 105 and cell gNB1 103. The cell gNB1 103 with frequency F1 is given a lower priority than the SIB4 message broadcasted cells. The SIB4 message broadcasted cells are either weak or not suitable for cell reselection.

At operation S307, since, the cell gNB1 103 is present in cell selection or reselection list and it is the best cell for cell reselection, the UE 101 attempts cell reselection on the cell gNB1 103.

At operation S309, the UE 101 completes the cell reselection on the cell gNB1 103 successfully.

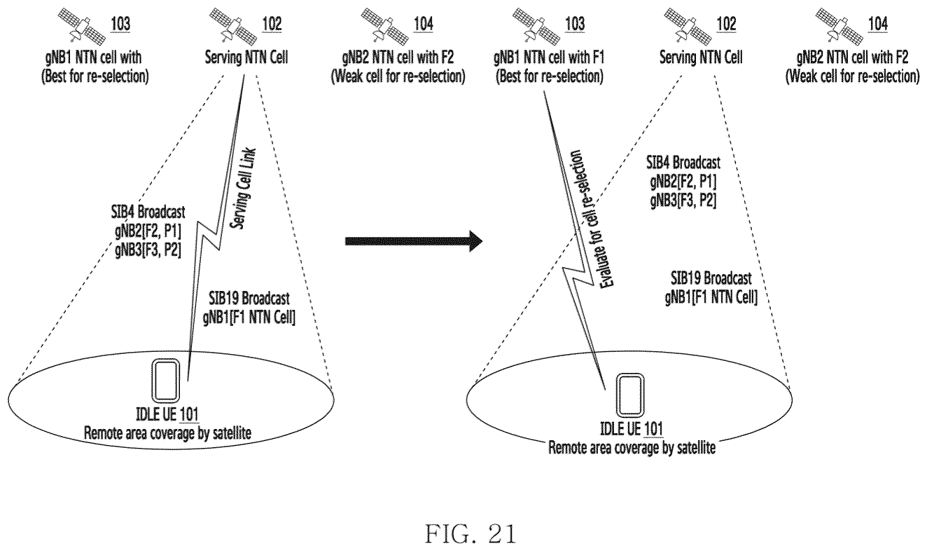

FIG. 21 is a schematic diagram that illustrates the SIB19 message cells evaluated during NTN cell reselection, according to the embodiment disclosed herein. FIG. 21 illustrates that the cell gNB1 103 information broadcasted in the SIB19 message is also considered for cell reselection. The UE candidate list for cell reselection includes cell gNB2 104, cell gNB3 105 and cell gNB1 103. The cell gNB1 103 with frequency F1 is given a lower priority than the SIB4 message broadcasted cells. Since, the cell gNB1 103 is present in the cell selection or reselection list and it is the best cell for cell reselection, the UE 101 attempts cell reselection on the cell gNB1 103. The UE 101 completes the cell reselection on the cell gNB1 103 successfully.

In an embodiment, the UE measures all the cells present in the SIB4 message according to cell reselection priority. Apart from this, cells from the SIB19 message neighbor cell list which are not present in the SIB4 message are also evaluated for cell reselection with lower priority. According to one or more embodiments, a holistic list of candidate reselection cell list is used by the UE to perform the cell reselection in the NTN network. With this approach, during NTN-NTN cell reselection, the UE evaluates all available cells and selects best suitable cell for reselection procedure. As a result, no available cells are omitted by the UE during NTN-NTN cell reselection.

The additional cells from the SIB19 message neighbor cell list that are added to reselection process are given lower priority than the SIB4 message broadcasted cells. In case if there are multiple cells from the SIB19 message, then internal UE derived priority can be given to these cells/frequencies based on multiple factors.

This ensures the NTN network service stability during RRC_IDLE state mobility. If NTN cells or NTN cells associated with frequencies broadcasted in the SIB4 message are not detected or found to be poor cells during cell reselection, the UE does not move to no service state. The UE evaluates and choose best suitable cell from the SIB19 message broadcasted neighbor cell list ensuring service stability in RRC_IDLE state. This also ensures having more number of candidates cells for NTN cell reselection procedure. With this approach, the UE is able to select best possible cell for reselection procedure among all available NTN cells.

The embodiments of the disclosure leverage satellite assistance information transmitted through the SIB19 message, in conjunction with the SIB4 message data, to execute a refined and efficient cell selection process. The resulting improvement in service continuity translates to a superior user experience for 5G services in the context of NTN networks mobility.

TABLE 7
SIB4 Broadcast Cells

| Cells/Frequencies | Priority |
|---|---|
| gNB3/F3 | P1 |
| gNB4/F4 | P2 |
| gNB5/F5 | P3 |

TABLE 8
SIB19 Broadcast Cells

Cells/Frequencies
gNB1/F1
gNB2/F2

TABLE 9
UE Cell selection or Reselection List

| | | |
|---|---|---|
| Cells/Frequencies | Signal Level | Priority |

| | | | |
|---|---|---|---|
| gNB3/F3 | −117 | dBm | P1 |
| gNB4/F4 | −118 | dBm | P2 |

| | | |
|---|---|---|
| gNB5/F5 | <Not Found> | P3 |

| | | | |
|---|---|---|---|
| gNB1/F1 | −89 | dBm | P4 |
| gNB2/F2 | −92 | dBm | P5 |

For example, the Table 7 indicates the SIB4 broadcasted cells and the Table 8 indicates the SIB19 broadcast cells. The Table 3 indicates the cell selection or reselection list. The cell selection or reselection list considers both SIB4 broadcasted cells and SIB19 broadcasted cells for NTN reselection procedure. Therefore, even if the SIB4 broadcasted cells are either weak or not found for reselection, the UE evaluates the SIB19 broadcasted cell gNB1 and cell gNB2 to attempt for reselection. Since the cell gNB1 is more suitable based on power level, the UE successfully completes reselection on the cell gNB1.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method, performed by a user equipment (UE) camping on a serving cell in a non-terrestrial network (NTN), the method comprising:
receiving, by the UE from the serving cell, a first message comprising a first set of information;
receiving, by the UE, a second message comprising a second set of information broadcasted by the serving cell, wherein the second set of information comprises information that is at least partially different from the first set of information;
generating, by the UE, a cell selection or reselection list based on the first set of information and the second set of information, wherein the cell selection or reselection list comprises a plurality of candidate cells; and
performing, by the UE, at least one network cell selection or reselection operation based on the cell selection or reselection list.

2. The method of claim 1,
wherein, in case that the UE is in an idle state, the first message corresponds to a first system information message comprising system information block (SIB) 4 for cell reelection and the second message corresponds to a second system information message comprising SIB 19 for NTN access,
wherein the first set of information comprises at least one of cell information or frequency information related to at least one neighbor cell, and
wherein the second set of information comprises at least one of cell information or frequency information related to at least one NTN neighbor cell and satellite assistant information for the at least one NTN neighbor cell.

3. The method of claim 1, wherein, in case that the UE is in a connected state, the first message corresponds to a radio resource control (RRC) reconfiguration message and the second message is a corresponds to system information message comprising SIB 19 for NTN access,
wherein the first set of information comprises at least one of cell information or frequency information related to at least one neighbor cell, and
wherein the second set of information comprises at least one of cell information or frequency information related to at least one NTN neighbor cell and satellite assistant information for the at least one NTN neighbor cell.

4. The method of claim 1, wherein the first set of information comprises:
cell information of at least one first candidate cells of the plurality of candidate cells, and
at least one of:
at least one frequency information of at least one candidate cell of the plurality of candidate cells, or
priority information of the at least one candidate cell.

5. The method of claim 1, wherein the information that is at least partially different from the first set of information comprises at least one of:
cell information of at least one second candidate cell of the plurality of candidate cells,
satellite assistant information,
at least one frequency information of the at least one second candidate cell of the plurality of candidate cells, or
priority information of the at least one second candidate cell.

6. The method of claim 1, wherein the generating, by the UE, the cell selection or reselection list based on the first set of information and the second set of information comprises:
receiving, by the UE, a third message comprising a third set of information from at least one neighbor UE associated with the serving cell, and
generating, by the UE, the cell selection or reselection list by using the first set of information, the second set of information, and the third set of information, and
wherein the first set of information comprises at least one of cell information or frequency information related to at least one neighbor cell,
wherein the second set of information comprises at least one of cell information or frequency information related to at least one NTN neighbor cell and satellite assistant information for the at least one NTN neighbor cell, and
wherein the third set of information comprises satellite assistant information of at least one cell that is included in the at least one neighbor cell of the first set of information and not included in the at least one neighbor cell of the second set of information.

7. The method of claim 6, wherein the receiving, by the UE, the third message comprises receiving the third message through a short-range communication between the UE and neighbor UEs associated with the serving cell, and
wherein the short-range communication corresponds to one of a Bluetooth low energy (BLE) communication, a near-field communication (NFC) or a ZigBee communication or any similar communication.

8. The method of claim 1, wherein the performing, by the UE, the at least one network cell selection or reselection operation based on the cell selection or reselection list comprises at least one of:
selecting, by the UE, an optimal candidate cell from the cell selection or reselection list;
performing, by the UE, measurements of at least one candidate cell from the plurality of candidate cells, selecting, by the UE, the optimal candidate cell from the cell selection or reselection list based on the measurements, sending, by the UE, a measurement report comprising the measurements to the optimal candidate cell, receiving, by the UE, a handover command from the optimal candidate cell, and performing, by the UE, a handover procedure on an optimal frequency associated with the optimal candidate cell; or
selecting, by the UE, the optimal candidate cell from the cell selection or reselection list, and selecting, by the UE, an optimal frequency of at least one candidate cell from the plurality of candidate cells for the cell selection or reselection.

9. The method of claim 8, wherein the selecting, by the UE, the optimal candidate cell from the cell selection or reselection list comprises:
assigning a first priority to at least one first candidate cell and a second priority to at least one second candidate cell in the cell selection or reselection list, wherein the at least one first candidate cell is retrieved from the first set of information, the at least one second candidate cell is retrieved from the second set of information, and the second priority is lower than the first priority;
selecting, by the UE, the optimal candidate cell from the at least one first candidate cell by evaluating the at least one first candidate cell based on the first priority and a third set of information received from at least one neighbor UE associated with the serving cell; and
selecting, by the UE, the optimal candidate cell from the at least one second candidate cell by evaluating the at least one second candidate cell based on the second priority and the third set of information received from the at least one neighbor UE associated with the serving cell, when the at least one first candidate cell are not the optimal candidate cell.

10. A user equipment (UE) for provisioning cell selection or reselection in a non-terrestrial network (NTN), the UE comprising:
at least one processor; and
memory storing instructions that, when executed by the at least one processor, cause the UE to:
camp the UE on a serving cell in the NTN;
receive a first message comprising a first set of information from the serving cell;
receive a second message comprising a second set of information broadcasted by the serving cell, wherein the second set of information comprises information that is at least partially different from the first set of information;
generate a cell selection or reselection list based on the first set of information and the second set of information, wherein the cell selection or reselection list comprises a plurality of candidate cells; and
perform at least one network cell selection or reselection operation based on the cell selection or reselection list.

11. The UE of claim 10, wherein, in case that the UE is in an idle state, the first message corresponds to a first system information message comprising system information block (SIB) 4 for cell reelection and the second message corresponds to a second system information message comprising SIB 19 for NTN access,
wherein the first set of information comprises at least one of cell information or frequency information related to at least one neighbor cell, and
wherein the second set of information comprises at least one of cell information or frequency information related to at least one NTN neighbor cell and satellite assistant information for the at least one NTN neighbor cell.

12. The UE of claim 10, wherein, in case that the UE is in a connected state, the first message corresponds to a radio resource control (RRC) reconfiguration message and the second message is a corresponds to system information message comprising SIB 19 for NTN access,
wherein the first set of information comprises at least one of cell information or frequency information related to at least one neighbor cell, and
wherein the second set of information comprises at least one of cell information or frequency information related to at least one NTN neighbor cell and satellite assistant information for the at least one NTN neighbor cell.

13. The UE of claim 10, wherein the first set of information comprises:
cell information of the at least one first candidate cell of the plurality of candidate cells, and
at least one of:
at least one frequency information of at least one candidate cell of the plurality of candidate cells, or
priority information of the at least one candidate cell.

14. The UE of claim 10, wherein the information that is at least partially different information from the first set of information comprises at least one of:
cell information of at least one second candidate cell of the plurality of candidate cells,
satellite assistant information,
at least one frequency information of at least one second candidate cell of the plurality of candidate cells, or
priority information of the at least one second candidate cell.

15. The UE of claim 10, wherein the cell selection or reselection provisioning controller is further configured to generate the cell selection or reselection list based on the first set of information and the second set of information by:
receiving a third message comprising the third set of information from the at least one neighbor UE associated with the serving cell; and
generating the cell selection or reselection list by mapping the first set of information and the second set of information with the third set of information,
wherein the first set of information comprises at least one of cell information or frequency information related to at least one neighbor cell,
wherein the second set of information comprises at least one of cell information or frequency information related to at least one NTN neighbor cell and satellite assistant information for the at least one NTN neighbor cell, and
wherein the third set of information comprises satellite assistant information of at least one cell that is included in the at least one neighbor cell of the first set of information and not included in the at least one neighbor cell of the second set of information.

16. The UE of claim 15, wherein the third message is received through a short-range communication between the UE and neighbor UEs associated with the serving cell, and
wherein the short-range communication corresponds to one of a Bluetooth low energy (BLE) communication, a near-field communication (NFC) or a ZigBee communication or any similar communication.

17. The UE of claim 10, wherein the instructions, when executed by the at least one processor, cause the UE to perform the at least one network cell selection or reselection operation based on the cell selection or reselection list by at least one of:
selecting an optimal candidate cell from the cell selection or reselection list;
performing measurements of at least one candidate cell from the plurality of candidate cells, selecting the optimal candidate cell from the cell selection or reselection list based on the measurements, sending a measurement report comprising the measurements to the optimal candidate cell, receiving a handover command from the optimal candidate cell, and performing a handover procedure on an optimal frequency associated with the optimal candidate cell; or
selecting the optimal candidate cell from the cell selection or reselection list, and selecting an optimal frequency of at least one candidate cell from the plurality of candidate cells for cell selection or reselection.

18. The UE of claim 17, wherein the instructions, when executed by the at least one processor, cause the UE to select the optimal candidate cell from the cell selection or reselection list by:
assigning a first priority to at least one first candidate cell and a second priority to at least one second candidate cell in the cell selection or reselection list, wherein the at least one first candidate cell is retrieved from the first set of information, the at least one second candidate cell is retrieved from the second set of information, and the second priority is lower than the first priority;
selecting the optimal candidate cell from the at least one first candidate cell by evaluating the at least one first candidate cell based on the first priority and a third set of information received from at least one neighbor UE associated with the serving cell; and
selecting the optimal candidate cell from the at least one second candidate cell by evaluating the at least one second candidate cell based on the second priority and the third set of information received from the at least one neighbor UE associated with the serving cell, when the at least one first candidate cell are not the optimal candidate cell.

19. A non-transitory computer readable storage medium comprising instructions that, when executed by at least one processor, causes a user equipment (UE) to:
receive, by the UE from the serving cell, a first message comprising a first set of information;
receive, by the UE, a second message comprising a second set of information broadcasted by the serving cell, wherein the second set of information comprises information that is at least partially different from the first set of information;
generate, by the UE, a cell selection or reselection list based on the first set of information and the second set of information, wherein the cell selection or reselection list comprises a plurality of candidate cells; and
perform, by the UE, at least one network cell selection or reselection operation based on the cell selection or reselection list.

20. The non-transitory computer readable storage medium of claim 19, wherein the instructions to generate, by the UE, the cell selection or reselection list based on the first set of information and the second set of information comprises by:
receiving, by the UE, a third message comprising a third set of information from at least one neighbor UE associated with the serving cell, and
generating, by the UE, the cell selection or reselection list by using the first set of information, the second set of information, and the third set of information, and
wherein the first set of information comprises at least one of cell information or frequency information related to at least one neighbor cell,
wherein the second set of information comprises at least one of cell information or frequency information related to at least one NTN neighbor cell and satellite assistant information for the at least one NTN neighbor cell, and
wherein the third set of information comprises satellite assistant information of at least one cell that is included in the at least one neighbor cell of the first set of information and not included in the at least one neighbor cell of the second set of information.
